(19) United States
(12) Patent Application Publication
(10) Pub. No.: US 2026/0025538 A1
(43) Pub. Date: Jan. 22, 2026

(54) Adaptive Streaming Content Selection for Playback Groups

(71) Applicant: Sonos, Inc., Goleta, CA (US)

(72) Inventors: Anthony John Parks, JR., Somerville, MA (US); Ryan James McGinley, Quincy, MA (US); Richard Jackson, Boston, MA (US)

(21) Appl. No.: 19/341,240

(22) Filed: Sep. 26, 2025

Related U.S. Application Data
(63) Continuation of application No. PCT/US2024/021749, filed on Mar. 27, 2024.
(60) Provisional application No. 63/492,477, filed on Mar. 27, 2023.

(51) Int. Cl. H04N 21/2387; H04N 21/242; H04N 21/258

(52) U.S. Cl. CPC H04N 21/2387; H04N 21/242; H04N 21/25833; H04N 21/25891

(57) ABSTRACT

A playback device is configured to (i) operate as part of a synchrony group including at least one other group member, (ii) obtain a respective indication of each group member's capability to play back media content, (iii) based on the respective indications, determine a group capability to play back media content, (iv) transmit, to a cloud-based computing system, a request for a media item, (v) receive, from the cloud-based computing system, a list of different renditions of the requested media item, the list including a respective media item identifier usable to obtain each different rendition, (vi) select a rendition of the requested media item that corresponds to the determined group capability, (vii) use a media item identifier corresponding to the selected rendition to retrieve the selected rendition of the requested media item, and (viii) play back the selected rendition in synchrony with the at least one other group member.

### CROSS-REFERENCE TO RELATED APPLICATIONS

This application is a continuation under 35 U.S.C. § 120 of International Application No. PCT/US2024/021749, filed Mar. 27, 2024 and titled “Adaptive Streaming Content Selection for Playback Groups,” which claims priority to U.S. Provisional Application No. 63/492,477, filed Mar. 27, 2023 and titled “Adaptive Streaming Content Selection for Playback Groups,” the contents of each of which are incorporated herein by reference in their entirety.

### FIELD OF THE DISCLOSURE

This disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, titled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

Given the ever-growing interest in digital media, there continues to be a need to develop consumer-accessible technologies to further enhance the listening experience.

### BRIEF DESCRIPTION OF THE DRAWINGS

FIG. 1A is a partial cutaway view of an environment having a media playback system configured in accordance with aspects of the disclosed technology.

FIG. 1B is a schematic diagram of the media playback system of FIG. 1A and one or more networks.

FIGS. 1C through 1E are block diagrams of example playback devices.

FIG. 1F is a block diagram of an example network microphone device.

FIG. 1G is a block diagram of an example playback device.

FIG. 1H is a partially schematic diagram of an example control device.

FIG. 1I is a schematic diagram of example user interfaces of the example control device of FIG. 1H.

FIGS. 1J through 1M are schematic diagrams of example corresponding media playback system zones.

FIG. 1N is a schematic diagram of example media playback system areas.

FIG. 2 is a diagram of an example headset assembly for an example playback device.

FIG. 3 is an isometric diagram of an example playback device housing.

FIG. 4 is a diagram of an example synchrony group according to one embodiment of the disclosed technology.

FIG. 5 is a flow diagram showing example operations for selecting a rendition of a media item for playback by a synchrony group.

FIG. 6 is a schematic diagram of an example user interface for selecting a user preference related to spatial audio playback.

FIG. 7 is a schematic diagram of an example user interface that indicates a status of a user preference related to spatial audio playback.

FIG. 8 is an example list of renditions for a requested media item.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

When engaged in a media playback experience, users expect media devices to play back media content (e.g., stream from cloud servers) in a seamless and continuous manner. In some instances, changes in the network connection quality between a media device and the cloud servers can cause disruptions in media playback as the media device runs out of buffered media content to play back, which can lead to a less than ideal user experience. As a result, during certain times when the connection is weak, the quality of the network connection between the media device and the cloud servers may be insufficient to support uninterrupted streaming of high-quality media content.

Users also expect media devices to provide high quality media content. High-resolution audio formats offer increased audio fidelity and dynamic range compared to standard resolution audio formats, and playback of high resolution audio content thus results in a more desirable and satisfying user experience. However, playing back high resolution audio typically requires sophisticated playback capabilities (e.g., increased processing power, digital rights management-capability, prolonged battery life, etc.) that may not be available to certain playback devices (e.g., older playback devices, portable playback devices, etc.). In instances where multiple playback devices are grouped for synchronous playback, the quality of the media content that is played back by the grouped playback devices may be impacted by the individual capabilities of the playback devices. As a result, when playback devices having less sophisticated capabilities are grouped with playback devices having more sophisticated capabilities for synchronous playback of high resolution audio content, the less-capable playback devices may be unable to play back the audio content, which may result in at least the less-capable devices (and perhaps also the other playback devices in the group) experiencing difficulty participating in synchronous group playback, thereby leading to an undesirable and unsatisfactory user experience. To address such challenges, SONOS, Inc., which is the assignee of the present application, has been continuously developing new technology to intelligently enhance the reliability of audio content playback. For example, SONOS, Inc. has developed technology to support conditional enhancement of audio content based on the capability of a playback device that is to play back the audio content and/or the quality of the network connection between the playback device and the content source. Such functionality, among others, is disclosed in U.S. Pat. No. 10,873,820, titled “Conditional Content Enhancement,” which is hereby incorporated by reference in its entirety.

Additionally, due to increased consumer expectations for High Definition (HD) audio, HD-quality media content has become more widely available from media content streaming services. In order to address safety concerns of digital music rights holders, media content streaming services that provide HD-quality content have begun to implement Digital Rights Management (DRM) protection mechanisms (e.g., Widevine encryption technology) that encrypt audio content, and encrypted audio content is then transmitted (e.g., via Dynamic Adaptive Streaming over HTTP (DASH)) from the media content service to a playback device for playback. The playback device then decrypts the audio content using information (e.g., key(s), certificate(s), etc.) that is obtained from a license server, and then plays the decrypted audio content. However, these types of encryption mechanisms are based on the premises that (i) the playback device requesting the encrypted audio content is the only device that will play back the content, and that (ii) the playback device requesting the encrypted audio content has sufficient computational resources to support decryption of the audio content. While these premises may hold true for a single playback device engaging in solo playback, they do not directly scale to the synchronous playback of audio content that is distributed among multiple playback devices in a media playback system, as this would require multiple endpoints communicating with the license server, and the playback device that requests the encrypted audio content from the media server is typically the only device that is authorized to obtain the information for decrypting the audio content from the license server and is typically prohibited from distributing the HD audio content in its decrypted format due to the security concerns. To address such challenges, SONOS, Inc. has built upon its previous innovations for enhancing audio experiences and has developed technology for encrypting audio content that is transmitted between playback devices within a networked media playback system, more information about which can be found in PCT Pub. No. US2022/028563, filed May 10, 2022, and entitled “Audio Encryption in a Media Playback System, which is hereby incorporated by reference in its entirety.

Additionally yet, SONOS, Inc. has appreciated that many modern users prefer to be informed about and involved in managing their media playback experiences. Therefore, SONOS, Inc. has also developed new technology for providing users with real-time visibility regarding media playback system characteristics related to media content quality and facilitating user-management of those characteristics. More information about these and other techniques is disclosed in PCT Pub. No. US 2022/240874, filed May 10, 2022, and entitled “Managing Content Quality and Related Characteristics of a Media Playback System,” the contents of which are hereby incorporated by reference in their entirety.

User expectations for access to higher quality media content have continued to rise, and media streaming services have been exploring ways to support those user needs. For instance, media streaming services have now begun to offer, in addition to other high-quality renditions, spatial audio renditions of some media items for playback by playback devices that have appropriate hardware to support spatial audio playback (e.g., upward firing transducers, etc.). Spatial audio can significantly enhance a listening experience by immersing a user in a three-dimensional audio environment. However, simply adding these additional renditions of a media item to the other renditions already provided by conventional adaptive streaming techniques (e.g., DASH, HTTP Live Streaming (HLS), etc.) does not sufficiently address the challenges presented by synchrony groups with differing member capabilities. In particular, as the number of available renditions of any given media item (e.g., a song) continues to increase, and the range of possible playback device capabilities concurrently continues to increase, managing and providing the best possible quality of playback by a synchrony group that includes group members that may have different capabilities is an increasingly challenging task.

Building upon previous innovation, SONOS, Inc. has continued to develop new technology for improving playback reliability and supporting higher quality audio content for playback, whenever it is available. The technology disclosed herein relates to adaptively selecting a rendition of a media item within an HLS playlist for playback by a synchrony group based on the capabilities of each playback device in the synchrony group. In this regard, the capability of each group member playback device may be based on combination of factors, including (1) respective hardware and software capabilities of the playback device, (2) a respective network quality associated with each playback device, and/or (3) respective user preference(s) regarding content playback by the playback device. As a result, the quality of the audio stream may be dynamically modified based on these (and other) factors to ensure reliable playback of audio in a wide variety of operating conditions.

For instance, two or more playback devices may be grouped for synchronous playback of audio content within a local media playback network. One of the playback devices may act as a “group coordinator,” evaluating the playback capability of each group member to thereby determine a collective group capability (e.g., by determining an intersection of all group member capabilities) and also requesting a media item (e.g., from an HLS media content provider) for playback by the synchrony group. Upon receiving the HLS playlist form the media content provider, the group coordinator may select, based on the determined group capability a rendition for playback by the synchrony group. Further the group coordinator may continue to monitor group member playback device capability, and thus group capability, during playback of the selected rendition. If the group capability changes (e.g., improves or degrades), the group coordinator may select a second rendition from the playlist that corresponds to the change, and then transition from playing back the initially selected rendition in synchrony with the group to playing back the second selected rendition in synchrony with the group.

Accordingly, in one aspect, disclosed herein is a playback device including at least one processor, a non-transitory computer-readable medium, and program instructions stored on the non-transitory computer-readable medium that are executable by the at least one processor such that the playback device is configured to: (i) operate as part of a synchrony group that comprises the playback device as a first group member and at least one other group member, (ii) obtain a respective indication of each group member's capability to play back media content, (iii) based on the respective indications of each group member's capability to play back media content, determine a group capability to play back media content, (iv) transmit, to a cloud-based computing system associated with a media service provider, a request for a media item to be played back by the synchrony group, (v) receive, from the cloud-based computing system associated with a media service provider, a list of different renditions of the requested media item, the list including a respective media item identifier that is usable to obtain each different rendition of the requested media item, (vi) select, from the list, a rendition of the requested media item for playback that corresponds to the determined group capability, (vii) use a media item identifier corresponding to the selected rendition of the requested media item to retrieve the selected rendition of the requested media item, and (viii) play back the selected rendition of the requested media item in synchrony with the at least one other group member.

In another aspect, disclosed herein is a non-transitory computer-readable medium. The non-transitory computer-readable medium is provisioned with program instructions that, when executed by at least one processor, cause a playback device to: (i) operate as part of a synchrony group that comprises the playback device as a first group member and at least one other group member, (ii) obtain a respective indication of each group member's capability to play back media content, (iii) based on the respective indications of each group member's capability to play back media content, determine a group capability to play back media content, (iv) transmit, to a cloud-based computing system associated with a media service provider, a request for a media item to be played back by the synchrony group, (v) receive, from the cloud-based computing system associated with a media service provider, a list of different renditions of the requested media item, the list including a respective media item identifier that is usable to obtain each different rendition of the requested media item, (vi) select, from the list, a rendition of the requested media item for playback that corresponds to the determined group capability, (vii) use a media item identifier corresponding to the selected rendition of the requested media item to retrieve the selected rendition of the requested media item, and (viii) play back the selected rendition of the requested media item in synchrony with the at least one other group member.

In yet another aspect, disclosed herein is a method carried out by a playback device that involves: (i) operating as part of a synchrony group that comprises the playback device as a first group member and at least one other group member, (ii) obtaining a respective indication of each group member's capability to play back media content, (iii) based on the respective indications of each group member's capability to play back media content, determining a group capability to play back media content, (iv) transmitting, to a cloud-based computing system associated with a media service provider, a request for a media item to be played back by the synchrony group, (v) receiving, from the cloud-based computing system associated with a media service provider, a list of different renditions of the requested media item, the list including a respective media item identifier that is usable to obtain each different rendition of the requested media item, (vi) selecting, from the list, a rendition of the requested media item for playback that corresponds to the determined group capability, (vii) using a media item identifier corresponding to the selected rendition of the requested media item to retrieve the selected rendition of the requested media item, and (viii) playing back the selected rendition of the requested media item in synchrony with the at least one other group member.

It will be understood by one of ordinary skill in the art that this disclosure includes numerous other embodiments. It will be understood by one of ordinary skill in the art that this disclosure includes numerous other examples. While some examples described herein may refer to functions performed by given actors such as “users” and/or other entities, it should be understood that this description is for purposes of explanation only. The claims should not be interpreted to require action by any such example actor unless explicitly required by the language of the claims themselves.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

### II. Suitable Operating Environment

a. Suitable Media Playback System

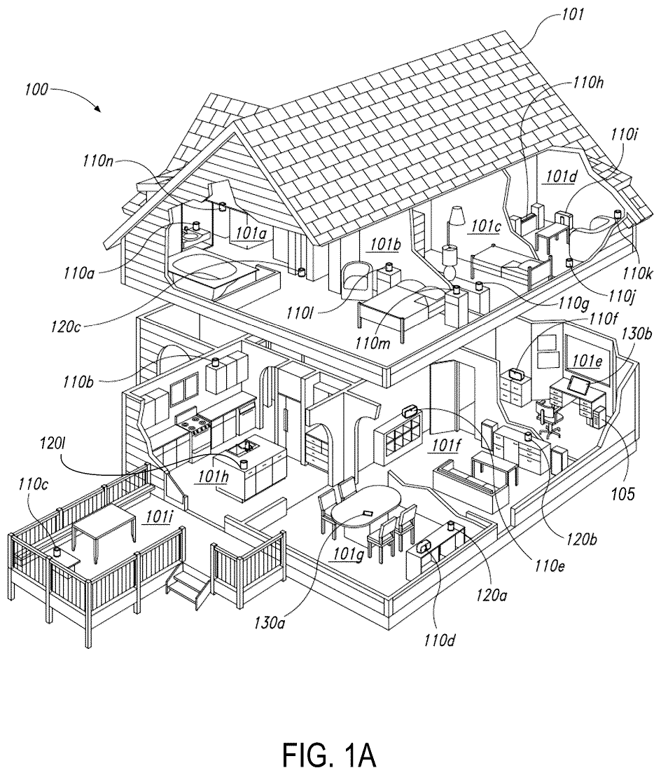

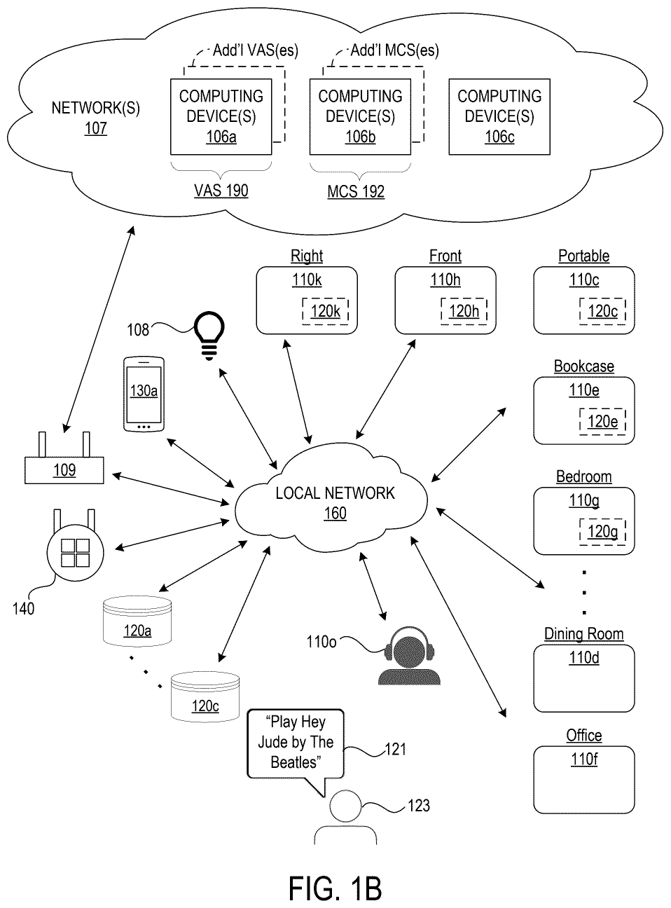

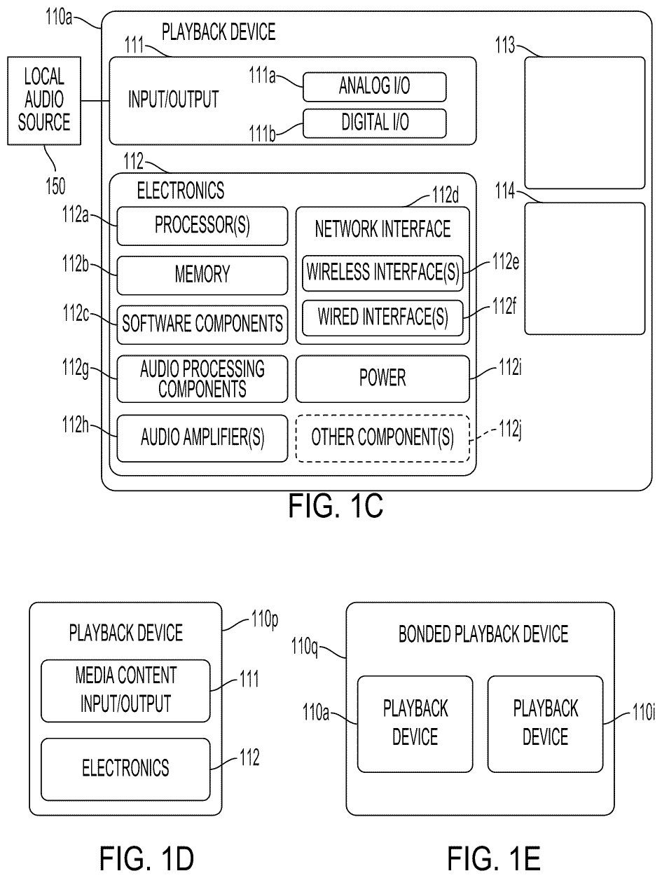

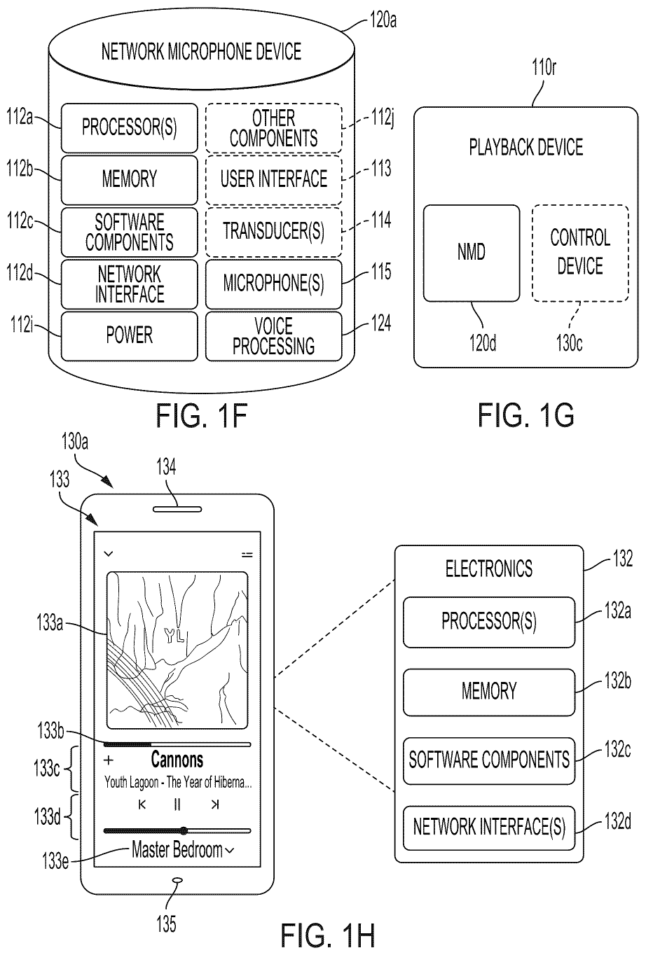

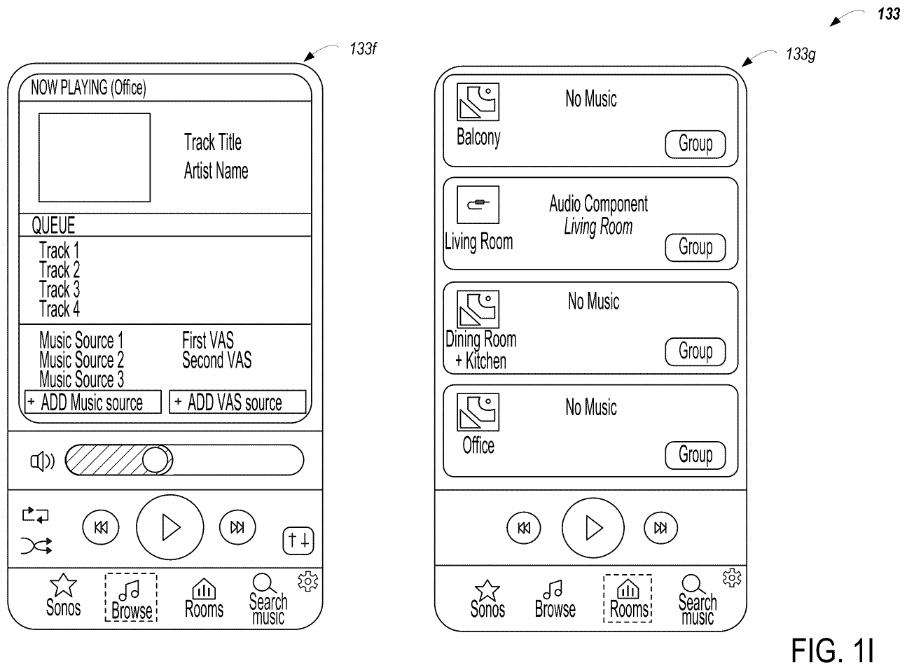

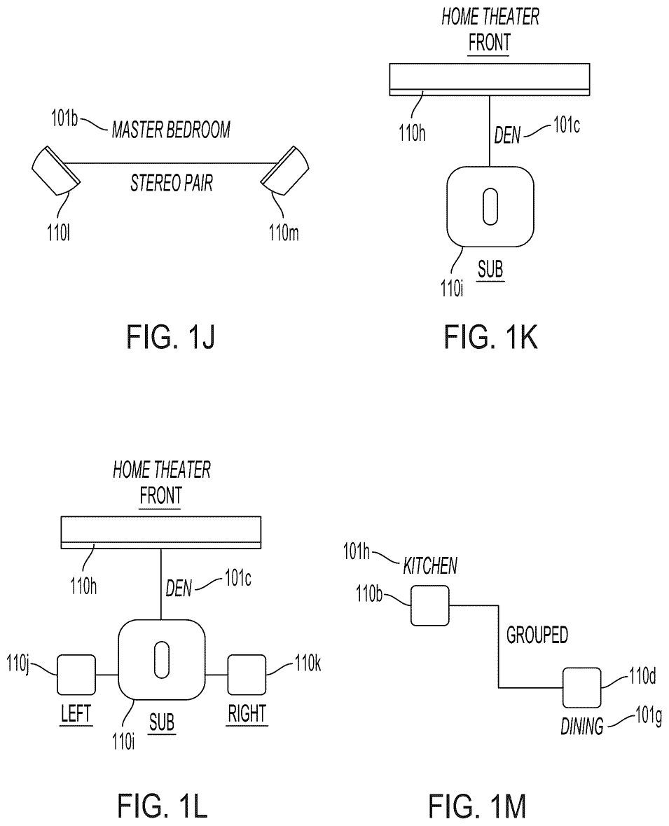

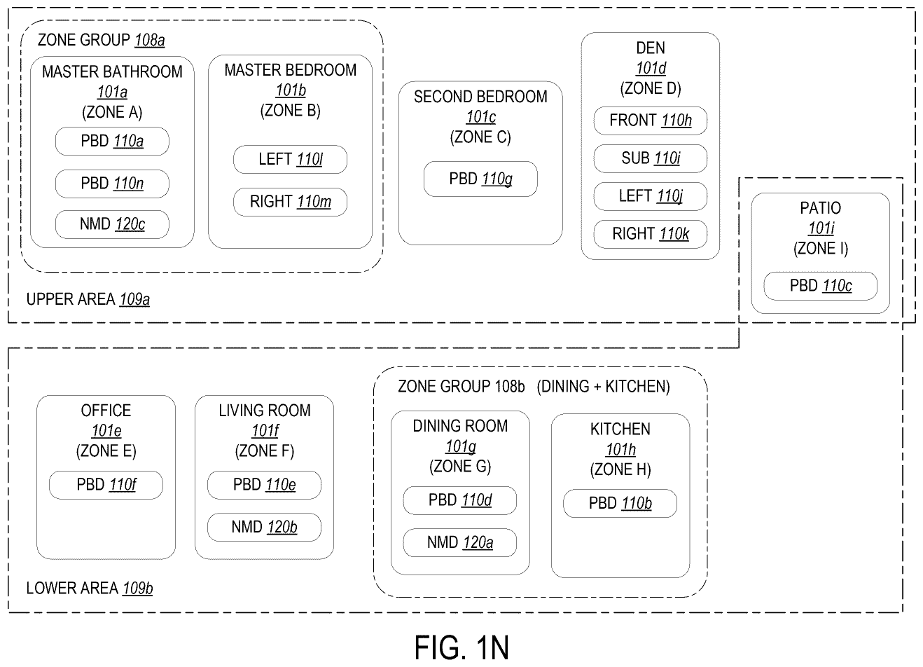

FIGS. 1A and 1B illustrate an example configuration of a media playback system (“MPS”) 100 in which one or more embodiments disclosed herein may be implemented. Referring first to FIG. 1A, a partial cutaway view of MPS 100 distributed in an environment 101 (e.g., a house) is shown. The MPS 100 as shown is associated with an example home environment having a plurality of rooms and spaces. The MPS 100 comprises one or more playback devices 110 (identified individually as playback devices 110a-o), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the MPS 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the MPS 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the MPS 100 is configured to play back audio from a first playback device (e.g., the playback device 110a) in synchrony with a second playback device (e.g., the playback device 110b). Interactions between the playback devices 110, NMDs 120, and/or control devices 130 of the MPS 100 configured in accordance with the various embodiments of the disclosure are described in greater detail below with respect to FIGS. 1B-1N.

In the illustrated embodiment of FIG. 1A, the environment 101 comprises a household having several rooms, spaces, and/or playback zones, including (clockwise from upper left) a Master Bathroom 101a, a Master Bedroom 101b, a Second Bedroom 101c, a Family Room or Den 101d, an Office 101e, a Living Room 101f, a Dining Room 101g, a Kitchen 101h, and an outdoor Patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The MPS 100 can comprise one or more playback zones, some of which may correspond to the rooms in the environment 101. The MPS 100 can be established with one or more playback zones, after which additional zones may be added and/or removed to form, for example, the configuration shown in FIG. 1A. Each zone may be given a name according to a different room or space such as the Office 101e, Master Bathroom 101a, Master Bedroom 101b, the Second Bedroom 101c, Kitchen 101h, Dining Room 101g, Living Room 101f, and/or the Patio 101i. In some aspects, a single playback zone may include multiple rooms or spaces. In certain aspects, a single room or space may include multiple playback zones.

In the illustrated embodiment of FIG. 1A, the Master Bathroom 101a, the Second Bedroom 101c, the Office 101e, the Living Room 101f, the Dining Room 101g, the Kitchen 101h, and the outdoor Patio 101i each include one playback device 110, and the Master Bedroom 101b and the Den 101d include a plurality of playback devices 110. In the Master Bedroom 101b, the playback devices 110l and 110m may be configured, for example, to play back audio content in synchrony as individual ones of playback devices 110, as a bonded playback zone, as a consolidated playback device, and/or any combination thereof. Similarly, in the Den 101d, the playback devices 110h-j can be configured, for instance, to play back audio content in synchrony as individual ones of playback devices 110, as one or more bonded playback devices, and/or as one or more consolidated playback devices.

Referring to FIG. 1B, the home environment may include additional and/or other computing devices, including local network devices, such as one or more smart illumination devices 108 (FIG. 1B), a smart thermostat 140 (FIG. 1B), and a local computing device 105 (FIG. 1A). Numerous other examples of local network devices (not shown) are also possible, such as doorbells, cameras, smoke alarms, televisions, gaming consoles, garage door openers, etc. In embodiments described below, one or more of the various playback devices 110 may be configured as portable playback devices, while others may be configured as stationary playback devices. For example, the headphones 110o (FIG. 1B) are a portable playback device, while the playback device 110e on the bookcase may be a stationary device. As another example, the playback device 110c on the Patio 101i may be a battery-powered device, which may allow it to be transported to various areas within the environment 101, and outside of the environment 101, when it is not plugged in to a wall outlet or the like.

With reference still to FIG. 1B, the various playback, network microphone, and controller devices and/or other network devices of the MPS 100 may be coupled to one another via point-to-point connections and/or over other connections, which may be wired and/or wireless, via a local network 160 that may include a network router 109. For example, the playback device 110j in the Den 101d (FIG. 1A), which may be designated as the “Left” device, may have a point-to-point connection with the playback device 110k, which is also in the Den 101d and may be designated as the “Right” device. In a related embodiment, the Left playback device 110j may communicate with other network devices, such as the playback device 110h, which may be designated as the “Front” device, via a point-to-point connection and/or other connections via the local network 160.

The local network 160 may be, for example, a network that interconnects one or more devices within a limited area (e.g., a residence, an office building, a car, an individual's workspace, etc.). The local network 160 may include, for example, one or more local area networks (LANs) such as a wireless local area network (WLAN) (e.g., a WIFI network, a Z-Wave network, etc.) and/or one or more personal area networks (PANs) (e.g. a BLUETOOTH network, a wireless USB network, a ZigBee network, an IRDA network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WIFI” can refer to several different communication protocols including, for example, Institute of Electrical and Electronics Engineers (IEEE) 802.11a, 802.11b, 802.11g, 802.12, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, 6 GHz, and/or another suitable frequency.

The MPS 100 is configured to receive media content from the local network 160. The received media content can comprise, for example, a Uniform Resource Identifier (URI) and/or a Uniform Resource Locator (URL). For instance, in some examples, the MPS 100 can stream, download, or otherwise obtain data from a URI or a URL corresponding to the received media content.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101 (FIG. 1A).

In some implementations, the various playback devices 110, NMDs 120, and/or control devices 130 may be communicatively coupled to at least one remote computing device associated with a voice assistant service (“VAS”) and/or at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to any number of different VASes and/or MCSes. In some embodiments, the various playback devices 110, NMDs 120, and/or control devices 130 may transmit data associated with a received voice input to a VAS configured to (i) process the received voice input data and (ii) transmit a corresponding command to the MPS 100. In some aspects, for example, the computing devices 106a may comprise one or more modules and/or servers of a VAS. In some implementations, VASes may be operated by one or more of SONOS®, AMAZON®, GOOGLE® APPLE®, MICROSOFT®, NUANCE®, or other voice assistant providers. In some implementations, MCSes may be operated by one or more of SPOTIFY, PANDORA, AMAZON MUSIC, YOUTUBE MUSIC, APPLE MUSIC, GOOGLE PLAY, or other media content services.

In some embodiments, the local network 160 comprises a dedicated communication network that the MPS 100 uses to transmit messages between individual devices and/or to transmit media content to and from MCSes. In certain embodiments, the local network 160 is configured to be accessible only to devices in the MPS 100, thereby reducing interference and competition with other household devices. In other embodiments, however, the local network 160 comprises an existing household communication network (e.g., a household WIFI network). In some embodiments, the MPS 100 is implemented without the local network 160, and the various devices comprising the MPS 100 can communicate with each other, for example, via one or more direct connections, PANs, telecommunication networks (e.g., an LTE network or a 5G network, etc.), and/or other suitable communication links.

In some embodiments, audio content sources may be regularly added and/or removed from the MPS 100. In some embodiments, for example, the MPS 100 performs an indexing of media items when one or more media content sources are updated, added to, and/or removed from the MPS 100. The MPS 100 can scan identifiable media items in some or all folders and/or directories accessible to the various playback devices and generate or update a media content database comprising metadata (e.g., title, artist, album, track length) and other associated information (e.g., URIs, URLs) for each identifiable media item found. In some embodiments, for example, the media content database is stored on one or more of the various playback devices, network microphone devices, and/or control devices of MPS 100.

As further shown in FIG. 1B, the remote computing devices 106 further include remote computing device(s) 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 110 may take the form of or include an on-board (e.g., integrated) network microphone device configured to detect sound, including voice utterances from a user. For example, the playback devices 110c-110h, and 110k include or are otherwise equipped with corresponding NMDs 120c-120h, and 120k, respectively. A playback device that includes or is equipped with an NMD may be referred to herein interchangeably as a playback device or an NMD unless indicated otherwise in the description. In some cases, one or more of the NMDs 120 may be a stand-alone device. For example, the NMD 1201 (FIG. 1A) may be a stand-alone device. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 110 and 120 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 110e because it is physically situated on a bookcase. Similarly, the NMD 1201 may be assigned the named “Island” because it is physically situated on an island countertop in the Kitchen 101h (FIG. 1A). Some playback devices may be assigned names according to a zone or room, such as the playback devices 110g, 110d, and 110f, which are named “Bedroom,” “Dining Room,” and “Office,” respectively. Further, certain playback devices may have functionally descriptive names. For example, the playback devices 110k and 110h are assigned the names “Right” and “Front,” respectively, because these two devices are configured to provide specific audio channels during media playback in the zone of the Den 101d (FIG. 1A). The playback device 110c in the Patio 101i may be named “Portable” because it is battery-powered and/or readily transportable to different areas of the environment 101. Other naming conventions are possible.

As discussed above, an NMD may detect and process sound from its environment, including audio output played by itself, played by other devices in the environment 101, and/or sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word (also referred to herein as an activation word) associated with a particular VAS.

In the illustrated example of FIG. 1B, the NMDs 120 are configured to interact with the VAS 190 over the local network 160 and/or the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 105, 110, 120, and 130 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. Pat. No. 10,499,146, issued Nov. 13, 2019 and titled “Voice Control of a Media Playback System,” which is herein incorporated by reference in its entirety.

Upon receiving the stream of sound data, the VAS 190 may determine if there is voice input in the streamed data from the NMD, and if so the VAS 190 may also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude” performed by The Beatles. After these determinations, the VAS 190 may transmit a command to a particular MCS 192 to retrieve content (i.e., the song “Hey Jude” by The Beatles), and that MCS 192, in turn, provides (e.g., streams) this content directly to the NIPS 100 or indirectly via the VAS 190. In some implementations, the VAS 190 may transmit to the NIPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 110e in the environment 101 (FIG. 1A) is in relatively close proximity to the NMD-equipped Living Room playback device 120b, and both devices 110e and 120b may at least sometimes detect the same sound. In such cases, this may require arbitration as to which device is ultimately responsible for providing detected-sound data to the remote VAS. Examples of arbitrating between NMDs may be found, for example, in previously referenced U.S. Pat. No. 10,499,146.

In certain implementations, an NMD may be assigned to, or otherwise associated with, a designated or default playback device that may not include an NMD. For example, the Island NMD 1201 in the Kitchen 101h (FIG. 1A) may be assigned to the Dining Room playback device 110d, which is in relatively close proximity to the Island NMD 1201. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Pat. No. 10,499,146.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback devices 110, network microphone devices 120, and/or control devices 130. For example, the technologies herein may be utilized within an environment having a single playback device 110 and/or a single NMD 120. In some examples of such cases, the local network 160 (FIG. 1B) may be eliminated and the single playback device 110 and/or the single NMD 120 may communicate directly with the remote computing devices 106a-c. In some embodiments, a telecommunication network (e.g., an LTE network, a 5G network, etc.) may communicate with the various playback devices 110, network microphone devices 120, and/or control devices 130 independent of the local network 160.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WIFI, BLUETOOTH, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 150 via the input/output 111 (e.g., a cable, a wire, a PAN, a BLUETOOTH connection, an ad hoc wired or wireless communication network, and/or another suitable communication link). The local audio source 150 can comprise, for example, a mobile device (e.g., a smartphone, a tablet, a laptop computer) or another suitable audio component (e.g., a television, a desktop computer, an amplifier, a phonograph, a DVD player, a Blu-ray player, a game console, a memory storing digital media files). In some aspects, the local audio source 150 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 150. In other embodiments, however, the media playback system omits the local audio source 150 altogether. In some embodiments, the playback device 110a does not include an input/output 111 and receives all audio content via the local network 160.

The playback device 110a further comprises electronics 112, a user interface 113 (e.g., one or more buttons, knobs, dials, touch-sensitive surfaces, displays, touchscreens), and one or more transducers 114 (e.g., a driver), referred to hereinafter as “the transducers 114.” The electronics 112 is configured to receive audio from an audio source (e.g., the local audio source 150) via the input/output 111, one or more of the computing devices 106a-c via the local network 160 (FIG. 1B), amplify the received audio, and output the amplified audio for playback via one or more of the transducers 114. In some embodiments, the playback device 110a optionally includes one or more microphones (e.g., a single microphone, a plurality of microphones, a microphone array) (hereinafter referred to as “the microphones”). In certain embodiments, for example, the playback device 110a having one or more of the optional microphones can operate as an NMD configured to receive voice input from a user and correspondingly perform one or more operations based on the received voice input, which will be discussed in more detail further below with respect to FIGS. 1F and 1G.

In the illustrated embodiment of FIG. 1C, the electronics 112 comprise one or more processors 112a (referred to hereinafter as “the processors 112a”), memory 112b, software components 112c, a network interface 112d, one or more audio processing components 112g, one or more audio amplifiers 112h (referred to hereinafter as “the amplifiers 112h”), and power components 112i (e.g., one or more power supplies, power cables, power receptacles, batteries, induction coils, Power-over Ethernet (POE) interfaces, and/or other suitable sources of electric power).

In some embodiments, the electronics 112 optionally include one or more other components 112j (e.g., one or more sensors, video displays, touchscreens, battery charging bases). In some embodiments, the playback device 110a and electronics 112 may further include one or more voice processing components that are operably coupled to one or more microphones, and other components as described below with reference to FIGS. 1F and 1G.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices and/or zones can be found, for example, in U.S. Pat. No. 8,234,395 entitled “System and method for synchronizing operations among a plurality of independently clocked digital data processing devices,” which is herein incorporated by reference in its entirety.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the MPS 100. In some aspects, for example, the state data is shared during predetermined intervals of time (e.g., every 5 seconds, every 10 seconds, every 60 seconds) among at least a portion of the devices of the MPS 100, so that one or more of the devices have the most recent data associated with the MPS 100.

The network interface 112d is configured to facilitate a transmission of data between the playback device 110a and one or more other devices on a data network. The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the local network 160 (FIG. 1B) in accordance with a suitable wireless communication protocol (e.g., WIFI, BLUETOOTH, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

In some implementations, the power components 112i of the playback device 110a may additionally include an internal power source (e.g., one or more batteries) configured to power the playback device 110a without a physical connection to an external power source. When equipped with the internal power source, the playback device 110a may operate independent of an external power source. In some such implementations, an external power source interface may be configured to facilitate charging the internal power source. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The user interface 113 may facilitate user interactions independent of or in conjunction with user interactions facilitated by one or more of the control devices 130 (FIG. 1A). In various embodiments, the user interface 113 includes one or more physical buttons and/or supports graphical interfaces provided on touch sensitive screen(s) and/or surface(s), among other possibilities, for a user to directly provide input. The user interface 113 may further include one or more light components (e.g., LEDs) and the speakers to provide visual and/or audio feedback to a user.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

In some embodiments, the playback device 110a may include a speaker interface for connecting the playback device to external speakers. In other embodiments, the playback device 110a may include an audio interface for connecting the playback device to an external audio amplifier or audio-visual receiver.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” “SUB,” “ARC,” “MOVE,” and “ROAM.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more of the playback devices 110 may comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device may omit a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with playback device 110i, is configured to render only the mid-range and high frequency components of a particular audio content, while the playback device 110i renders the low frequency component of the particular audio content. In some embodiments, the bonded playback device 110q includes additional playback devices and/or another bonded playback device.

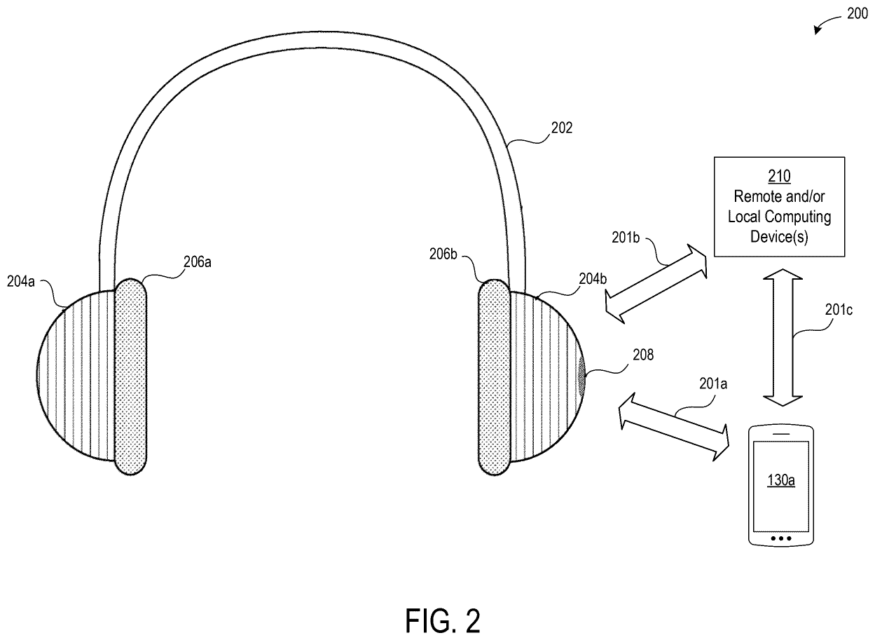

In some embodiments, one or more of the playback devices 110 may take the form of a wired and/or wireless headphone device (e.g., over-ear headphones, on-ear headphones, in-ear earphones, etc.). For instance, FIG. 2 shows an example headset assembly 200 (“headset 200”) for such an implementation of one of the playback devices 110. As shown, the headset 200 includes a headband 202 that couples a first earcup 204a to a second earcup 204b. Each of the earcups 204a and 204b may house any portion of the electronic components in the playback device 110, such as one or more speakers. Further, one or both of the earcups 204a and 204b may include a user interface for controlling audio playback, volume level, and other functions. The user interface may include any of a variety of control elements such as a physical button 208, a slider (not shown), a knob (not shown), and/or a touch control surface (not shown). As shown in FIG. 2, the headset 200 may further include ear cushions 206a and 206b that are coupled to ear cups 204a and 204b, respectively. The ear cushions 206a and 206b may provide a soft barrier between the head of a user and the earcups 204a and 204b, respectively, to improve user comfort and/or provide acoustic isolation from the ambient (e.g., passive noise reduction (PNR)).

As described in greater detail below, the electronic components of a playback device may include one or more network interface components (not shown in FIG. 2) to facilitate wireless communication over one more communication links. For instance, a playback device may communicate over a first communication link 201a (e.g., a BLUETOOTH link) with one of the control devices 130, such as the control device 130a, and/or over a second communication link 201b (e.g., a WIFI or cellular link) with one or more other computing devices 410 (e.g., a network router and/or a remote server). As another possibility, a playback device may communicate over multiple communication links, such as the first communication link 201a with the control device 130a and a third communication link 201c (e.g., a WIFI or cellular link) between the control device 130a and the one or more other computing devices 410. Thus, the control device 130a may function as an intermediary between the playback device and the one or more other computing devices 410, in some embodiments.

In some instances, the headphone device may take the form of a hearable device. Hearable devices may include those headphone devices (including ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.)

It should be appreciated that one or more of the playback devices 110 may take the form of other wearable devices separate and apart from a headphone device. Wearable devices may include those devices configured to be worn about a portion of a user (e.g., a head, a neck, a torso, an arm, a wrist, a finger, a leg, an ankle, etc.). For example, the playback devices 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

c. Suitable Network Microphone Devices (NMDs)

FIG. 1F is a block diagram of the NMD 120a (FIGS. 1A and 1B). The NMD 120a includes one or more voice processing components 124 and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise any or all of the components of the playback device 110a and further include the microphones 115 and voice processing components 124 (FIG. 1F). The microphones 115 are configured to detect sound (i.e., acoustic waves) in the environment of the playback device 110r, which may then be provided to voice processing components 124. More specifically, each microphone 115 is configured to detect sound and convert the sound into a digital or analog signal representative of the detected sound, which can then cause the voice processing component to perform various functions based on the detected sound, as described in greater detail below. In some implementations, the microphones 115 may be arranged as an array of microphones (e.g., an array of six microphones). In some implementations the playback device 110r may include fewer than six microphones or more than six microphones. The playback device 110r optionally includes an integrated control device 130c. The control device 130c can comprise, for example, a user interface configured to receive user input (e.g., touch input, voice input) without a separate control device. In other embodiments, however, the playback device 110r receives commands from another control device (e.g., the control device 130a of FIG. 1B).

In operation, the voice-processing components 124 are generally configured to detect and process sound received via the microphones 115, identify potential voice input in the detected sound, and extract detected-sound data to enable a VAS, such as the VAS 190 (FIG. 1B), to process voice input identified in the detected-sound data. The voice processing components 124 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 124 may include or otherwise take the form of one or more DSPs or one or more modules of a DSP. In this respect, certain voice processing components 124 may be configured with particular parameters (e.g., gain and/or spectral parameters) that may be modified or otherwise tuned to achieve particular functions. In some implementations, one or more of the voice processing components 124 may be a subcomponent of the processor 112a.

In some implementations, the voice-processing components 124 may detect and store a user's voice profile, which may be associated with a user account of the MPS 100. For example, voice profiles may be stored as and/or compared to variables stored in a set of command information or data table. The voice profile may include aspects of the tone of frequency of a user's voice and/or other unique aspects of the user's voice, such as those described in previously-referenced U.S. Pat. No. 10,499,146.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The NMD 120a may use the microphone data (or transmit the microphone data to another device) for calibrating the audio characteristics of one or more playback devices 110 in the MPS 100. As another example, one or more of the playback devices 110, NMDs 120, and/or control devices 130 of the MPS 100 may transmit audio tones (e.g., ultrasonic tones, infrasonic tones) that may be detectable by the microphones 115 of other devices, and which may convey information such as a proximity and/or identity of the transmitting device, a media playback system command, etc. As yet another example, the voice processing components 124 may receive and analyze the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partially schematic diagram of one example of the control device 130a (FIGS. 1A and 1B). As used herein, the term “control device” can be used interchangeably with “controller,” “controller device,” or “control system.” Among other features, the control device 130a is configured to receive user input related to the MPS 100 and, in response, cause one or more devices in the MPS 100 to perform an action(s) and/or an operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the MPS 100. In other embodiments, as described above with respect to FIG. 1G, the control device 130a is integrated into another device in the MPS 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processor(s) 132a”), a memory 132b, software components 132c, and a network interface 132d. The processor(s) 132a can be configured to perform functions relevant to facilitating user access, control, and configuration of the MPS 100. The memory 132b can comprise data storage that can be loaded with one or more of the software components executable by the processors 132a to perform those functions. The software components 132c can comprise applications and/or other executable software configured to facilitate control of the MPS 100. The memory 132b can be configured to store, for example, the software components 132c, media playback system controller application software, and/or other data associated with the MPS 100 and the user.

The network interface 132d is configured to facilitate network communications between the control device 130a and one or more other devices in the MPS 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.12, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among other changes. Additional description of zones and groups can be found below with respect to FIGS. 1J through 1N.

The user interface 133 is configured to receive user input and can facilitate control of the MPS 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system. FIG. 1I shows two additional example user interface displays 133f and 133g of user interface 133. Additional examples are also possible.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1J, 1K, 1L, 1M, and 1N show example configurations of playback devices in zones and zone groups. Referring first to FIG. 1N, in one example, a single playback device may belong to a zone. For example, the playback device 110g in the Second Bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities), as will be described in more detail further below. In other implementations, multiple playback devices may be merged to form a single zone. As one example, the playback device 110a can be bonded to the playback device 110n and the NMD 120c to form Zone A. As another example, the playback device 110h (e.g., a front playback device) may be merged with the playback device 110i (e.g., a subwoofer), and the playback devices 110j and 110k (e.g., left and right surround speakers, respectively) to form a single Zone D. In yet other implementations, one or more playback zones can be merged to form a zone group (which may also be referred to herein as a merged group). As one example, the playback zones Zone A and Zone B can be merged to form Zone Group 108a. As another example, the playback zones Zone G and Zone H can be merged to form Zone Group 108b. The merged playback zones Zone G and Zone H may not be specifically assigned different playback responsibilities. That is, the merged playback zones Zone G and Zone H may, aside from playing audio content in synchrony, each play audio content as they would if they were not merged and operating as independent zones.

Each zone in the MPS 100 may be represented for control as a single user interface (UI) entity. For example, Zone A may be represented as a single entity named Master Bathroom. Zone B may be represented as a single entity named Master Bedroom. Zone C may be represented as a single entity named Second Bedroom.

In some implementations, as mentioned above playback devices that are bonded may have different playback responsibilities, such as responsibilities for certain audio channels. For example, as shown in FIG. 1J, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1K, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1L shows the Front and SUB devices 110h and 110i further bonded with Left and Right playback devices 110j and 110k, respectively. In some implementations, the Right and Left devices 110j and 110k can be configured to form surround or “satellite” channels of a home theater system. The bonded playback devices 110h, 110i, 110j, and 110k may form a single Zone D (FIG. 1N).

In other implementations, playback devices that are merged may not have assigned playback responsibilities and may each render the full range of audio content of which the respective playback device is capable. Nevertheless, merged devices may be represented as a single UI entity (i.e., a zone, as discussed above). For instance, the playback devices 110a and 110n in the Master Bathroom have the single UI entity of Zone A. In one embodiment, the playback devices 110a and 110n may each output the full range of audio content of which each respective playback devices 110a and 110n is capable, in synchrony.

In some embodiments, an NMD may be bonded or merged with one or more other devices so as to form a zone. As one example, the NMD 120c may be merged with the playback devices 110a and 110n to form Zone A. As another example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. Pat. No. 10,499,146.

As mentioned above, in some implementations, zones of individual, bonded, and/or merged devices may be grouped to form a zone group. For example, referring to FIG. 1N, Zone A may be grouped with Zone B to form a zone group 108a that includes the two zones, and Zone G may be grouped with Zone H to form the zone group 108b. However, other zone groupings are also possible. For example, Zone A may be grouped with one or more other Zones C-I. The Zones A-I may be grouped and ungrouped in numerous ways. For example, three, four, five, or more (e.g., all) of the Zones A-I may be grouped at any given time. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zone groups in an environment may be named by according to a name of a zone within the group or a combination of the names of the zones within a zone group. For example, Zone Group 108b can be assigned a name such as “Dining+Kitchen”, as shown in FIG. 1N. In other implementations, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “al” to identify playback device(s) of a zone, a second type “bl” to identify playback device(s) that may be bonded in the zone, and a third type “cl” to identify a zone group to which the zone may belong. As a related example, identifiers associated with the Second Bedroom 101c may indicate (i) that the playback device 110g is the only playback device of the Zone C and (ii) that Zone C is not in a zone group. Identifiers associated with the Den 101d may indicate that the Den 101d is not grouped with other zones but includes bonded playback devices 110h-110k. Identifiers associated with the Dining Room 101g may indicate that the Dining Room 101g is part of the Dining+Kitchen Zone Group 108b and that devices 110d and 110b (Kitchen 101h) are grouped (FIGS. 1M, 1N). Identifiers associated with the Kitchen 101h may indicate the same or similar information by virtue of the Kitchen 101h being part of the Dining+Kitchen Zone Group 108b. Other example zone variables and identifiers are described below.

In yet another example, the MPS 100 may include variables or identifiers representing other associations of zones and zone groups, such as identifiers associated with Areas, as shown in FIG. 1N. An area may involve a cluster of zone groups and/or zones not within a zone group. For instance, FIG. 1N shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, issued Jul. 14, 2020, and titled “Room Association Based on Name,” and U.S. Pat. No. 8,483,853, filed Sep. 11, 2007, issued Jul. 9, 2013, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

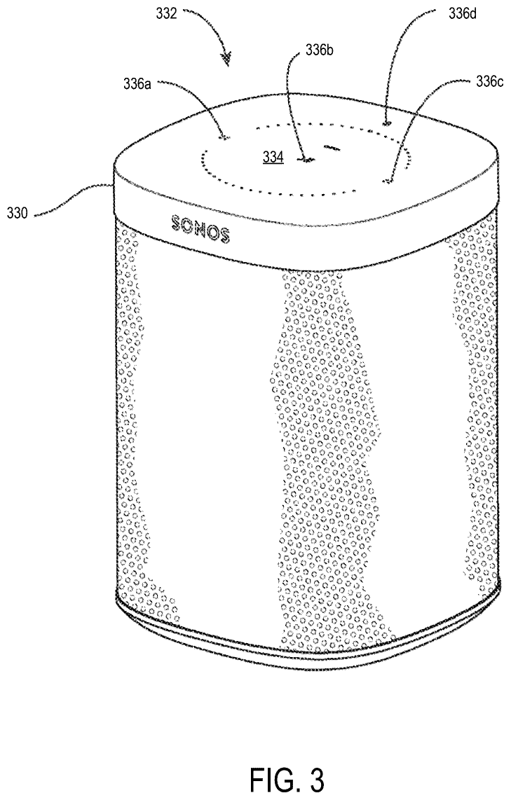

FIG. 3 shows an example housing 330 of the playback device 110 that includes a user interface in the form of a control area 332 at a top portion 334 of the housing 330. The control area 332 includes buttons 336a, 336b, and 336c for controlling audio playback, volume level, and other functions. The control area 332 also includes a button 336d for toggling one or more microphones (not visible in FIG. 3) of the playback device 110 to either an on state or an off state. The control area 332 is at least partially surrounded by apertures formed in the top portion 334 of the housing 330 through which the microphones receive the sound in the environment of the playback device 110. The microphones may be arranged in various positions along and/or within the top portion 334 or other areas of the housing 330 so as to detect sound from one or more directions relative to the playback device 110.

f. Audio Content

Audio content may be any type of audio content now known or later developed. For example, in some embodiments, the audio content includes any one or more of: (i) streaming music or other audio obtained from a streaming media service, such as Spotify, Pandora, or other streaming media services; (ii) streaming music or other audio from a local music library, such as a music library stored on a user's laptop computer, desktop computer, smartphone, tablet, home server, or other computing device now known or later developed; (iii) audio content associated with video content, such as audio associated with a television program or movie received from any of a television, set-top box, Digital Video Recorder, Digital Video Disc player, streaming video service, or any other source of audio-visual media content now known or later developed; (iv) text-to-speech or other audible content from a voice assistant service (VAS), such as Amazon Alexa, Google Assistant, or other VAS services now known or later developed; (v) audio content from a doorbell or intercom system such as Nest, Ring, or other doorbells or intercom systems now known or later developed; and/or (vi) audio content from a telephone, video phone, video/teleconferencing system or other application configured to allow users to communicate with each other via audio and/or video.

In operation, a “sourcing” playback device obtains any of the aforementioned types of audio content from an audio source via an interface on the playback device, e.g., one of the sourcing playback device's network interfaces, a “line-in” analog interface, a digital audio interface, or any other interface suitable for receiving audio content in digital or analog format now known or later developed.

An audio source is any system, device, or application that generates, provides, or otherwise makes available any of the aforementioned audio content to a playback device. For example, in some embodiments, an audio source includes any one or more of a streaming media (audio, video) service, digital media server or other computing system, VAS service, television, cable set-top-box, streaming media player (e.g., AppleTV, Roku, gaming console), CD/DVD player, doorbell, intercom, telephone, tablet, or any other source of digital audio content.

A playback device that receives or otherwise obtains audio content from an audio source for playback and/or distribution to other playback devices may be referred to herein as the “sourcing” playback device, “master” playback device, a “group coordinator” playback device, or simply a “group coordinator.” One function of the “sourcing” playback device is to process received audio content for playback and/or distribution to other playback devices. In some embodiments, the sourcing playback device transmits the processed audio content to all the playback devices that are configured to play the audio content. In other embodiments, the sourcing playback device transmits the processed audio content to a multicast network address, and all the other playback devices configured to play the audio content receive the audio content via that multicast address. In yet other embodiments, the sourcing playback device alternatively transmits the processed audio content to a respective unicast network address of each other playback device configured to play the audio content, and each of the other playback devices configured to play the audio content receive the audio content via its respective unicast address.

### III. Example Techniques for Content Quality Enhancement

As mentioned above, conventional adaptive streaming techniques are generally designed to deliver streaming media content for playback by a single playback device that requested the media content. Consequently, in scenarios involving two or more playback devices (i.e., group members) that are grouped for synchronous playback of media content, a group coordinator playback device of the group will, in general, make a media content request to the streaming media source on behalf of the group. Further, in the case of HTTP live streaming (HLS), the group coordinator may be responsible for determining which rendition of the requested media content within a received HTTP playlist should be selected and played. However, the selection of which rendition of a requested media item to play back in order to provide the best user experience may depend on numerous factors, many of which may be subject to change, perhaps even during playback.

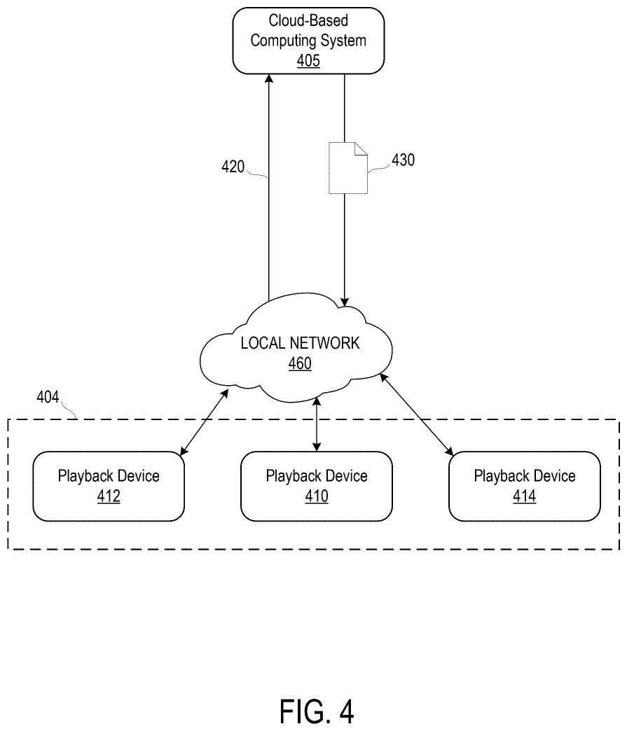

One possible example of this type of arrangement is shown in FIG. 4, which depicts a schematic diagram showing a set of playback devices 410, 412, and 414 configured as a synchrony group 404 that may obtain and play back media content from a cloud-based computing system 405 via an HLS communication protocol. The synchrony group 404 may operate in a media playback system, such as the media playback system 100 shown in FIGS. 1A-1B, and the cloud-based computing system 520 may be similar to or the same as the media content service 192 shown in FIG. 1B. The playback devices 410, 412, and 414 are grouped for synchronous playback of audio content and configured to coordinate and/or communicate over a local network 460, which may resemble the local network 160 shown in FIG. 1B, which in turn may be facilitated by a local network device, such as the wireless router 109 shown in FIG. 1B. Each of the playback devices in the synchrony group 404 may be identified as a group member, with the playback device 410 serving as group coordinator of the synchrony group 404. It should be understood that although the synchrony group 404 shows two additional group members 412 and 414 grouped with the group coordinator 410 for synchronous playback, it should be understood that any number of playback devices may be included in the synchrony group 404.

As group coordinator, the playback device 410 may generally be responsible for various tasks, including but not limited to, identifying audio content for playback by the synchrony group 404, transmitting the identified audio content and playback timing information to one or more group members, monitoring device characteristics of one or more group members, monitoring network characteristics associated with one or more group members, monitoring group characteristics, dynamically modifying audio content for playback based on a change in one or more characteristics, collecting and/or storing characteristics throughout the course of a grouped playback session, and/or providing the collected and/or stored characteristics to a remote computing system, among other possibilities.

As noted, among the responsibilities of the playback device 410 as group coordinator is a responsibility for transmitting a request to the cloud-based computing system 405 for one or more media items for playback by the synchrony group 404. A visual representation of such a request 420 is shown in FIG. 4. In response, the cloud-based computing system 405 may return to the playback device 410 an HLS playlist 430 that enumerates multiple different renditions of the requested media item and a respective media item identifier (e.g., a URI, a URL, etc.) that is usable to obtain each different rendition of the requested media item. For disambiguation from other uses of the word “playlist” in the description above, the examples that follow will refer to an HLS playlist instead as an HLS list 430, or simply a list 430.

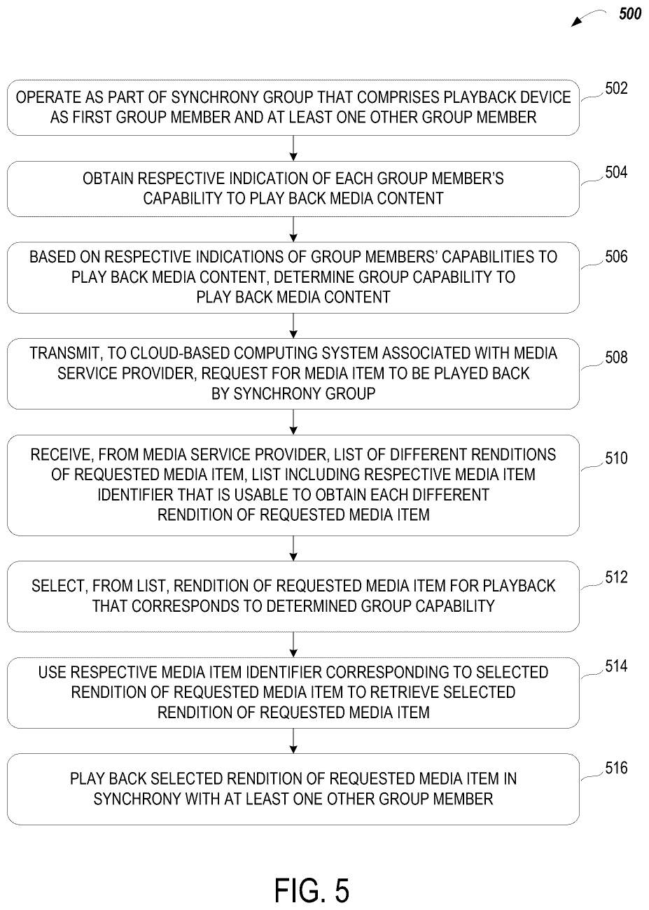

Turning now to FIG. 5, a flowchart 500 is shown that illustrates one example implementation for adaptively selecting media content for playback by a group of playback device that have been configured for synchronous playback. The operations shown in FIG. 5 may be carried out by a playback device that is acting as a group coordinator of the synchrony group. For the purposes of discussing the flowchart 500, the examples below will refer to the playback device 410 acting as a group coordinator for the synchrony group 404 shown in FIG. 4.

At block 502, the playback device 410 may operate as part of the synchrony group 404 that includes the playback device 410 as a first group member and at least one other group member, including the playback device 412 and the playback device 414. This arrangement is generally shown in FIG. 4,

At block 504, the playback device 410 may obtain a respective indication of each group member's capability to play back media content. In this regard, a group member's respective capability to play back media content may be based on several different factors, including the hardware and/or software of the group member, one or more network quality indicators associated with the group member, and one or more user preference settings associated with the group member. Each of these factors may take various forms.

For instance, the hardware and/or software of a given playback device may dictate what types of content it can handle, as certain older models of playback devices may be limited with respect to what audio codec(s), and/or bit rates they are capable of handling. Further, a playback device's hardware and/or software may dictate whether it is capable of playing back the additional audio channels that are found within spatial audio content. Other example of playback capabilities that are based on a playback device's hardware and/or software are also possible.

As another possibility, a group member's capability to play back media content may be based on a network quality associated with the group member, as reduced network bandwidth or network connection issues may degrade a playback device's capability to play back media content regardless of its hardware and/or software capabilities. In this regard, network quality associated with a group member may be determined in various ways. As one example, if the group member is currently playing back media content of a given content quality and bit rate, a duration of media content in a buffer of the group member may be used as a proxy for network quality. For instance, if the group member consistently maintains an expected buffer size (e.g., the next 10 seconds of media content), then the network quality may be determined to be equal to or better than a network quality required to stream media content of the given content quality and bit rate. On the other hand, if the group member cannot maintain a buffer of the expected size, it may indicate that the network quality associated with the group member is not sufficient for media content of the given quality and bit rate. In other implementations, the network quality associated with the group member may be determined by analyzing a quality of connection (e.g., signal strength, latency, etc.) between the group member and another network device, such as a wireless router. Other examples are also possible.

As yet another possibility, a group member's capability to play back media content may be based on a user preference associated with the group member. As one possibility, some users may prefer that a given playback device does not play back available spatial audio content, even though the playback device includes hardware that could enable such playback. For example, the user may prefer to hear more traditional, stereo mixed renditions of their favorite music, rather than spatial renditions which may be relatively newer renditions to which the user is not accustomed.

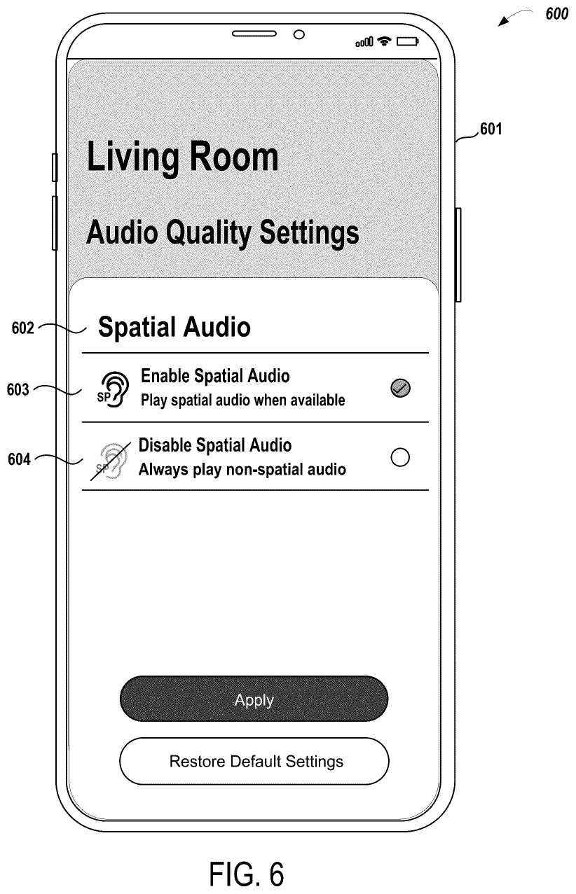

FIG. 6 shows a schematic diagram of an example user interface 601 that may be presented via an example control device 600. In this regard, the example control device 600 may be any of the control devices 130 discussed above and shown in FIGS. 1A-1B. As shown in FIG. 6, the user interface 601 shows an audio quality setting menu for a Living Room playback device, which may be the group coordinator playback device 410 shown in FIG. 4. The user interface 601 includes an indication 602 of Spatial Audio, which may indicate that the playback device 410 includes hardware to enable playback of spatial audio content. Further, the user interface 601 includes two selectable options for how the playback device 410 should handle spatial audio content when it is available. The first selectable option 603 indicates a selection to play back spatial audio content whenever it is available, whereas the second selectable option 604 indicates a selection to always play back non-spatial audio. In this regard, if the second selectable option 604 is selected, the playback device 410 will play back non-spatial audio even if spatial audio is available. Consequently, the playback device 410 is not capable of spatial audio playback when the second selectable option 604 is selected.

Although not shown in FIG. 6, it should be understood that the quality setting shown via the user interface 601 may include more granular preference setting than those shown in FIG. 6. For instance, a user might be able to select a user preference for spatial audio content that distinguishes between strictly audio content (e.g., music playback) and audio content that is synchronized with video content (e.g., home theater content playback).

In some other implementations, a user might save a user preference for a given playback device that indicates a maximum quality level of bit rate that the playback device should play back, as a means of limiting the network bandwidth that the playback device users. Other possibilities also exist.

A group member's capability to play back media content may be based on other factors as well.

The playback device 410 may obtain an indication of group member capabilities in various ways. In some implementations, the playback device 410 may request updates from each group member regarding its respectively playback capability at regular intervals (e.g., every second, etc.) or irregular intervals, which may trigger a response from each respective group member. As another possibility, each group member may send indications of its playback capability to the playback device at regular or irregular intervals. For example, the group members may send indications to the playback device 410 based on detecting that they have been grouped for synchronous playback. Further, the group members may additionally or alternatively send the indications periodically throughout grouped playback. Still further, one or more group members may additionally or alternatively send an indication upon detecting a change in its capability to play back media content. Other examples are also possible.

At block 506, the playback device 410 may, based on the respective indications of each group member's capability to play back media content, determine a group capability to play back media content. In some cases, determining the group capability may involve determining an intersection of all of the group members' capabilities. In this way, the group capability will generally correspond to the capability of the least capable group member for each of the factors noted above.

As one example, the playback device 410 may be capable of playing back spatial audio content, as shown in FIG. 6, but neither of the playback device 412 and 414 shown in the synchrony group 404 of FIG. 4 include hardware that would enable spatial audio, and thus the playback device 410 may determine that the synchrony group 404 is not capable of playing back spatial audio. Rather, the playback device 410 may determine that the synchrony group 404, based on the other capabilities of its group members, is capable of playing back non-spatial content having a given encoding quality and bit rate.

As another example, each of the playback devices in the synchrony group 404 may include hardware that would enable spatial audio, but the playback device 412 may include a user preference that spatial audio not be played. In a scenario where the playback device 410 determines an intersection of group member capabilities, the playback device would determine that the synchrony group 404 is not capable of playing back spatial audio.

On the other hand, in instances involving user preference for or against spatial audio content, the playback device 410 may use its own preference setting, as group coordinator, to determine the groups capability. For instance, taking the prior example again, in which each of the playback devices in the synchrony group 404 includes hardware that would enable spatial audio, but the playback device 412 includes a user preference that spatial audio not be played, the playback device 410 may nonetheless determine that the synchrony group 404 does include the capability to play back spatial audio, based on its own user preference setting shown in FIG. 6.

In view of the above, it will be appreciated that group capability may be subject to change dynamically based on both changes to individual group capabilities as well changes in group composition (i.e., the addition or removal of a group member from the group).

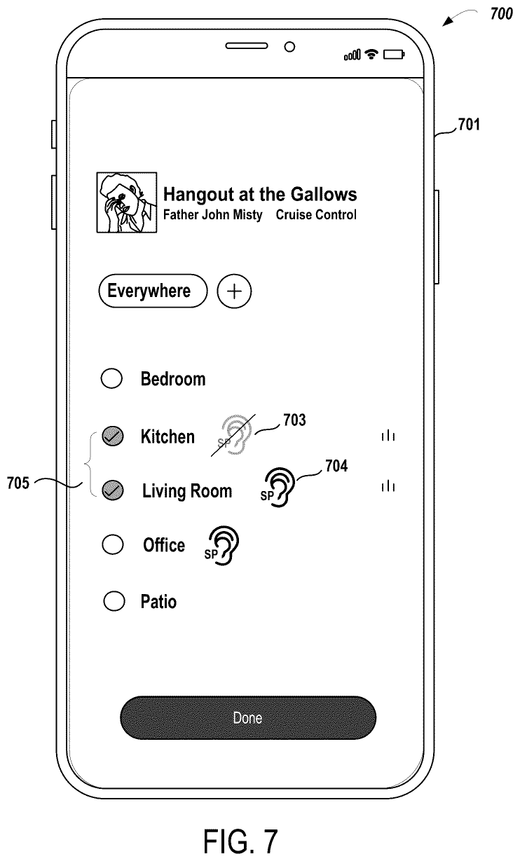

Turning to FIG. 7, a schematic diagram is shown of an example user interface 701 that may be presented via an example control device 700. In this regard, the example control device 700 may be any of the control devices 130 discussed above and shown in FIGS. 1A-1B. As shown in FIG. 7, the user interface 701 depicts an example grouping menu that may be used to group or ungroup playback devices. The Living Room playback device 410 and a Kitchen playback device, which may be the playback device 412 shown in FIG. 4, are the only two group members shown in an example synchrony group 705. The user interface 701 additionally includes an indication, for each playback device in the list, whether or not the playback device includes hardware that would enable spatial audio and if so, whether a user preference for spatial audio is on or off. For example, the indication 704 denotes that the Living Room playback device has a user preference for spatial audio turned on, whereas the indication 703 denotes that the Kitchen playback device includes hardware that would enable spatial audio, but has a user preference for non-spatial audio.

Within the example synchrony group 705, the Living Room playback device, as the group coordinator, may determine that the synchrony group 705 is capable of playing back spatial audio content, by virtue of its own user preference setting, as discussed above. This capability may not change if the Office playback device is added to the group. However, if either of the Bedroom or Patio playback devices are added to the synchrony group, the Living Room playback device may determine that the synchrony group no longer has the capability to play back spatial audio content. Other examples are also possible.

At block 508, the playback device 410 may transmit, to the cloud-based computing system 405 shown in FIG. 4, a request for a media item to be played back by the synchrony group. The cloud-based computing system 405 may be associated with a media service provider and may provide to the playback device 410 a list of renditions of the requested media item, as discussed below. Thus, in some cases, it may not be necessary for the playback device 410 to include an indication of the group capability in the request to the cloud-based computing system 405.

In some other implementations, the playback device 410 may be configured to include an indication of the determined group capability with the request to play back media content. This may be to cover scenarios in which one of the playback devices in the synchrony group 404 is an older, legacy that is not capable of handling some or all of the required processing that is necessary for playback of HLS streams (e.g., decryption of encrypted audio content, etc.). In these scenarios, the cloud-based computing system 405 may transmit a legacy audio track to the playback device 410 for playback by the synchrony group, rather than an HLS list of renditions discussed below. Alternatively, the playback device 410 may request, and receive, an HLS list as discussed below, even in scenarios where a legacy playback device in include in the synchrony group, and the list may allow the playback device 410 to transition to a higher quality rendition of the media item if the legacy playback device leaves the group.

At block 510, the playback device 410 may receive, from the cloud-based computing system 405 associated with a media service provider, a list of different renditions of the requested media item, such as the list 430 shown in FIG. 4. The list 430 may include a respective media item identifier that is usable to obtain each different rendition of the requested media item.

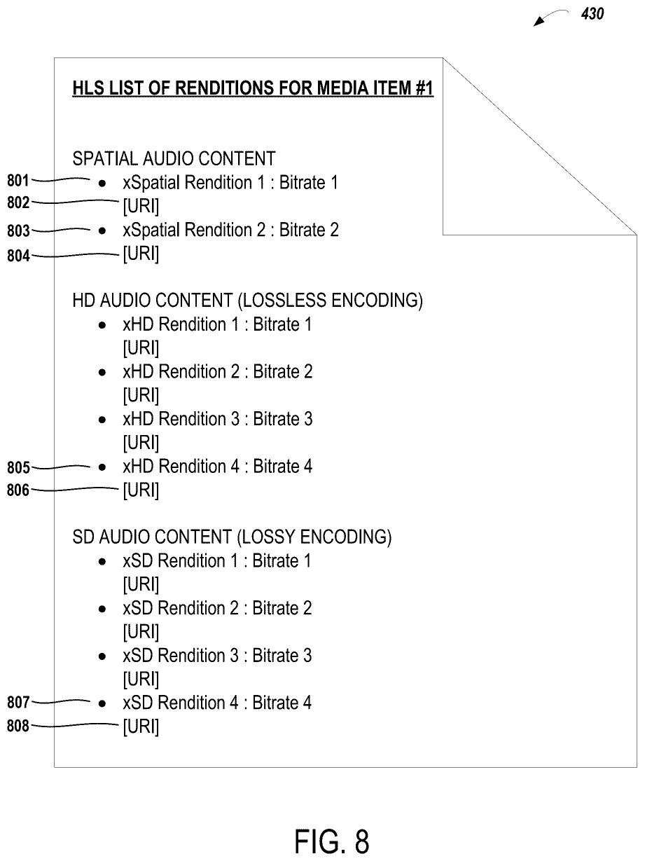

FIG. 8 illustrates one possible example of the list 430. As shown in FIG. 8, the list 430 includes a first tier that includes spatial audio renditions the requested media item, including a first spatial audio rendition 801 having a first bit rate that is retrievable at the URI 802. Further, the list 430 includes a second spatial audio rendition 803 having a second bit rate that is retrievable at the URI 804. Next, the list 430 includes two tiers of non-spatial audio renditions, including four renditions of both HD, lossless encodings at four different bit rates as well as four standard definition (SD), lossy encodings at four different bit rates.

At block 512, the playback device 410 may select, from the list, a rendition of the requested media item for playback that corresponds to the determined group capability. In some cases, the playback device 410 may select, within the quality tier (i.e., spatial, lossless, or lossy) that corresponds to the determined group capability, the lowest bit rate that is available, as an initial selection. Thereafter, the playback device 410 may assess the network quality of the synchrony group and transition to higher quality versions as appropriate.

At block 514, the playback device 410 may use a media item identifier corresponding to the selected rendition of the requested media item to retrieve the selected rendition of the requested media item.

In some cases, the playback device 410 may adjust a loudness of spatial and non-spatial tracks differently. For example, the playback device 410 may obtain an indication of a reference loudness value to be used for playback of media content. Thereafter, if a spatial audio rendition of the requested media item is selected, the playback device 410 may apply a predetermined gain offset to adjust a loudness of the spatial audio rendition to meet the reference loudness value. Alternatively, if a non-spatial audio rendition of the requested media item is selected, the playback device 410 may determine a baseline loudness of the non-spatial audio rendition of the requested media item (e.g., based on metadata for the rendition, by sampling the non-spatial audio rendition, etc.), then determine a gain offset to adjust the baseline loudness of the non-spatial audio rendition of the requested media item to meet the reference loudness value. Lastly, the playback device 410 may apply the determined gain offset to non-spatial audio rendition of the requested media item.

At block 516, the playback device 410 may play back the selected rendition of the requested media item in synchrony with the at least one other group member.

As mentioned above, the playback device 410 may obtain respective indications of each group member's capability to play back media content on an ongoing basis, including during the playback of an initially selected rendition of the requested media item. In some cases, a change in an individual group member's capability to play back media content may affect the determined group capability to play back media content. In this regard, a change in a group member's capability might take various forms, including a change in a group member's individual characteristics (e.g., a network quality associated with the group member), a change in a playback setting associated with a group member (e.g., a playback setting dictating the group member's individual capability to play back spatial audio content), or a change in group membership (e.g., if a group member leave or is added to the group), as discussed further in the examples below.

As one possibility, a change in a group member's capability may comprise a change in the group member's individual characteristics. As one example, the group member's individual characteristics may include a network quality associated with the group member. In this respect, the network quality may indicate a quality of a connection between the group member playback device and a network device (e.g., a router) of the media playback system. The quality of a connection between a playback device and a network device may be identified in various ways. In one implementation, the quality of the connection between the group member and the network device may be identified based on a buffer size of the group member. In this regard, the buffer size may indicate the strength of the connection quality. For instance, if the group member is able to buffer a threshold amount (e.g., 10 seconds, 15 seconds, etc.) of the media item that is being played back, it may be determined that the group member has a higher connection quality with the network device. On the other hand, if the group member is unable to buffer the threshold amount of the media item that is being played back, and the group member's buffer size is less than the threshold amount (e.g., 3 seconds), it may be determined that the group member has a lower connection quality with the network device that would make the group member susceptible to playback interruptions. A change in such a network quality of the group member may be indicated by an increase or a decrease in the group member's buffer size. For instance, at a first time of monitoring the playback capability of the synchrony group 404, the group coordinator 410 may determine that the group member 412 has a buffer size of 12 seconds, which may be above a threshold buffer size of 10 seconds. At a second time of monitoring the playback capability of the synchrony group 404, the group coordinator 410 may determine that the group member 412 has a buffer size of 5 seconds, which is below the threshold buffer size of 10 seconds. Thus, the group coordinator 410 may determine that the group member 412 has experienced a change in an individual characteristic that affects the group playback capability and thus requires transitioning to a different rendition of the requested media item in order to maintain uninterrupted synchronous playback.

In other implementations, the quality of the connection between the group member and the network device may be identified based on consumption of bandwidth by the group member or based on an evaluation of the current latency associated with the connection between the group member and the network device, as explained in more detail in U.S. Application No. [20-1201p] previously incorporated herein.

A change in a group member's individual characteristics may take other forms as well.

As another possibility, a change in a group member's capability may comprise a change in a playback setting associated with the group member. As mentioned above with respect to FIGS. 6-7, a listener may interact with a user interface displayed at a control device, such as the control device 601, to configure an audio quality setting of a playback device that dictates how the playback device is to handle playback of spatial audio content. For instance, a user may have configured a respective audio quality setting for each of the playback devices 410, 412, and 414 dictating whether or not the playback device should play back spatial audio content. For example, in one implementation, the user may have configured the respective audio quality settings for the playback devices 410, 412, and 414 to select the setting 603 to enable spatial audio such that each of the playback devices are configured to play back a spatial audio rendition version of a requested media item if available. In line with the discussion above, based on the respective audio quality settings of each of the playback devices 410, 412, 414, the group coordinator 410 may have determined that the playback capability of the synchrony group 404 supports playback of spatial audio content and may thus have selected a spatial audio content rendition of the requested media item (e.g., rendition 803 of FIG. 8) for playback by the synchrony group 404. However, while monitoring the group's playback capability during playback, the group coordinator 410 may determine that a respective audio quality setting of at least one of the group members has changed. For instance, while the synchrony group 404 is playing back the spatial audio rendition of the requested media item, the user may have updated the respective audio quality setting for at least the group coordinator 410 to switch the spatial audio setting from the setting 603 to the setting 604 to disable spatial audio such that the group coordinator 410 is configured to play back only non-spatial audio content, despite being equipped with hardware that provides the group coordinator 410 with the capability to play back spatial audio content.

In another implementation, the user may have configured the respective audio quality settings of the playback devices 410, 412, and 414 to select the setting 604 to disable spatial audio such that the playback devices 410, 412, and 414 are configured to play back only non-spatial audio content, despite being equipped with hardware that provides them with the capability to play back spatial audio content. In line with the discussion above, based on the respective audio quality settings of each of the playback devices 410, 412, 414, the group coordinator 410 may have determined that the playback capability of the synchrony group 404 does not support playback of spatial audio content and may thus have selected a non-spatial audio content rendition of the requested media item (e.g., rendition 805 of FIG. 8) for playback by the synchrony group 404. However, while monitoring the group's playback capability during playback, the group coordinator 410 may determine that a respective audio quality setting of at least one of the group members has changed. For instance, while the synchrony group 404 is playing back the non-spatial audio rendition of the requested media item, the user may have updated the respective audio quality setting for at least the group coordinator 410 to switch the spatial audio setting from the setting 604 to the setting 603 to enable spatial audio such that the group coordinator 410 is configured to play back a spatial audio rendition version of a requested media item if available.

A change in a playback setting associated with a group member may take other forms as well.

As yet another possibility, a change in a group member's capability make comprise a change in membership of the synchrony group. For instance, as one example, a new group member may join the synchrony group 404. The new group member may have individual playback capabilities that are different from the playback devices 410, 412, and 414 that affect playback of spatial audio content. For instance, the playback devices 410, 412, and 414 may have respective capabilities that support playback of spatial audio content in line with the discussion above. However, the new playback device may have a respective capability that does not support playback of spatial audio content (e.g., perhaps the new playback device is not equipped with the requisite hardware to support spatial audio playback, or perhaps an audio quality setting of the new playback device has been configured to disable spatial audio playback, etc.). Thus, the group coordinator 410 may determine that the playback capability of the group has changed such that it no longer supports playback of spatial audio.

Another example of a change in group membership may comprise a group member leaving the synchrony group 404. For instance, at the time of initially selecting a rendition of the requested item for playback, the group coordinator 410 may have determined that based on a respective capability of the group member 414, the playback capability of the synchrony group 404 does not support playback of spatial audio content. Thus, the group coordinator 410 may have selected a non-spatial audio rendition of the requested media item (e.g., rendition 805 or 807 from the HLS list 430 shown in FIG. 8) for playback by the synchrony group 404. However, during playback of the non-spatial audio rendition, the group member 414 may leave the group 404. The group coordinator 410 may then determine that based on the respective playback capabilities of the remaining group members 410 and 412, the playback capability of the group 404 has changed such that it now supports playback of spatial audio content. Other examples of changes in group membership are also possible.

A change in the group capability to play back media content based on a change in an individual group member's capability may take other forms as well.

In the event that the playback device 410 determines a change in the determined group capability to play back media content during playback of a first rendition of the requested media item as described above, the playback device 410 may obtain a second rendition of the requested media item for playback by the synchrony group. The second rendition of the requested media item may depend on the type of change in the determined group capability and may take various forms. For instance, as one possibility, if the change in the determined group capability comprises a decreased capability (e.g., inability) to support spatial audio content, the group coordinator 410 may select a second rendition of the requested media item that has a lower bit rate than the first rendition. For instance, with reference to the HLS list 430 shown in FIG. 8, if the first rendition of media item #1 comprised a spatial audio rendition, then the group coordinator 410 may select an HD rendition of media item #1 as the second rendition. Depending on the implementation, the group coordinator 410 may select either the lowest bit rate rendition or the highest bit rate HD rendition as the second rendition. As another possibility, if the change in the determined group capability comprises an increased capability to support spatial audio content, the group coordinator 410 may select a second rendition of the requested media item that comprises a spatial audio rendition of the requested media item. In this regard, if the first rendition of the requested media item was a spatial audio rendition, then the second rendition may comprise a higher bit rate spatial audio rendition. On the other hand, if the first rendition of the requested media item was a non-spatial audio rendition, then the second rendition may comprise the lowest bit rate spatial audio rendition available, in line with the discussion above.

In any event, after determining which given rendition to select as the second rendition, the playback device 410 may use a respective media item identifier (e.g., URI) for the second rendition provided in the HLS list 430 to obtain the second rendition of the requested media item.

After obtaining the second rendition, the group coordinator 410 may cause the synchrony group 404 to transition from playing back the first rendition to playing back the second rendition, which may generally comprise the group coordinator 410 causing each group member 412 and 414 to play back the second rendition and playing back the second rendition in synchrony with the playback of the group members 412 and 414. Transitioning from playing back the first rendition to playing back the second rendition may take various forms.

As one possibility, if the second rendition of the requested media item is a lower bit rate rendition than the first rendition, the group coordinator 410 may cause the playback group 404 to transition at the next audio boundary (e.g., the next audio frame) to minimize disruptions in playback, as the playback group is no longer capable of supporting playback of the first rendition. As another possibility, if the second rendition of the requested media item is a higher bit rate rendition than the first rendition, the group coordinator 410 may cause the playback group 404 to transition to the second rendition after playback of the current media item is complete. Advantageously, transitioning in this way can provide a more seamless listening experience because the shift from lower quality audio (e.g., non-spatial) to higher quality audio (e.g., spatial) during playback of a media item can be jarring to the user, and it may thus be more desirable to implement the shift to higher quality playback during the break between media items. For instance, if the group capability changes from not supporting playback of spatial audio to supporting playback of spatial audio, the playback device 410 may obtain a second rendition (spatial rendition) of the next media item that the playback group 404 is to play.

FIG. 5 includes one or more operations, functions, or actions as illustrated by one or more of operational blocks. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

In addition, for the flowchart shown in FIG. 5 and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the processes and methods disclosed herein, each block in FIG. 5 may represent circuitry and/or machinery that is wired or arranged to perform the specific functions in the process.

### IV. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

Further, the examples described herein may be employed in systems separate and apart from media playback systems such as any Internet of Things (IoT) system comprising an IoT device. An IoT device may be, for example, a device designed to perform one or more specific tasks (e.g., making coffee, reheating food, locking a door, providing power to another device, playing music) based on information received via a network (e.g., a WAN such as the Internet). Example IoT devices include a smart thermostat, a smart doorbell, a smart lock (e.g., a smart door lock), a smart outlet, a smart light, a smart vacuum, a smart camera, a smart television, a smart kitchen appliance (e.g., a smart oven, a smart coffee maker, a smart microwave, and a smart refrigerator), a smart home fixture (e.g., a smart faucet, a smart showerhead, smart blinds, and a smart toilet), and a smart speaker (including the network accessible and/or voice-enabled playback devices described above). These IoT systems may also comprise one or more devices that communicate with the IoT device via one or more networks such as one or more cloud servers (e.g., that communicate with the IoT device over a WAN) and/or one or more computing devices (e.g., that communicate with the IoT device over a LAN and/or a PAN). Thus, the examples described herein are not limited to media playback systems.

It should be appreciated that references to transmitting information to particular components, devices, and/or systems herein should be understood to include transmitting information (e.g., messages, requests, responses) indirectly or directly to the particular components, devices, and/or systems. Thus, the information being transmitted to the particular components, devices, and/or systems may pass through any number of intermediary components, devices, and/or systems prior to reaching its destination. For example, a control device may transmit information to a playback device by first transmitting the information to a computing system that, in turn, transmits the information to the playback device. Further, modifications may be made to the information by the intermediary components, devices, and/or systems. For example, intermediary components, devices, and/or systems may modify a portion of the information, reformat the information, and/or incorporate additional information.

Similarly, references to receiving information from particular components, devices, and/or systems herein should be understood to include receiving information (e.g., messages, requests, responses) indirectly or directly from the particular components, devices, and/or systems. Thus, the information being received from the particular components, devices, and/or systems may pass through any number of intermediary components, devices, and/or systems prior to being received. For example, a control device may receive information from a playback device indirectly by receiving information from a cloud server that originated from the playback device. Further, modifications may be made to the information by the intermediary components, devices, and/or systems. For example, intermediary components, devices, and/or systems may modify a portion of the information, reformat the information, and/or incorporate additional information.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

Further, in light of the above detailed description, the present disclosure contemplates the following example features.

(Feature 1) A playback device comprising at least one processor, a non-transitory computer-readable medium, and program instructions stored on the non-transitory computer-readable medium that are executable by the at least one processor such that the playback device is configured to (i) operate as part of a synchrony group that comprises the playback device as a first group member and at least one other group member, (ii) obtain a respective indication of each group member's capability to play back media content, (iii) based on the respective indications of each group member's capability to play back media content, determine a group capability to play back media content, (iv) transmit, to a cloud-based computing system associated with a media service provider, a request for a media item to be played back by the synchrony group, (v) receive, from the cloud-based computing system associated with a media service provider, a list of different renditions of the requested media item, the list including a respective media item identifier that is usable to obtain each different rendition of the requested media item, (vi) select, from the list, a rendition of the requested media item for playback that corresponds to the determined group capability, (vii) use a media item identifier corresponding to the selected rendition of the requested media item to retrieve the selected rendition of the requested media item, and (viii) play back the selected rendition of the requested media item in synchrony with the at least one other group member.

(Feature 2) The playback device of feature 1, wherein the request for the media item to be played back by the synchrony group comprises an indication of the determined group capability to play back media content.

(Feature 3) The playback device of feature 1, wherein each media item identifier comprises a uniform resource indicator (URI).

(Feature 4) The playback device of feature 1, wherein the selected rendition is a first selected rendition, the playback device further comprising program instructions stored on the non-transitory computer-readable medium that are executable by the at least one processor such that the playback device is configured to (i) during playback of the first selected rendition of the requested media item, determine a change in the group capability to play back media content, (ii) based on the determined change in the group capability to play back media content, select, from the list of different renditions, a second rendition of the requested media item for playback that corresponds to the changed group capability, (iii) use the media item identifier corresponding to the second selected rendition of the requested media item retrieve the second selected rendition of the requested media item, and (iv) transition from playing back the first selected rendition of the requested media item in synchrony with the at least one other group member to playing back the second selected rendition of the requested media item in synchrony with the at least one other group member.

(Feature 5) The playback device of feature 4, wherein the program instructions that are executable by the at least one processor such that the playback device is configured to determine the change in the group capability to play back media content comprise program instructions that are executable by the at least one processor such that the playback device is configured to determine that a buffer of at least one group member in the synchrony group does not include a threshold amount of the selected rendition of the requested media item, wherein the second selected rendition of the requested media items comprises a lower bit rate rendition than the first selected rendition.

(Feature 6) The playback device of feature 4, wherein the program instructions that are executable by the at least one processor such that the playback device is configured to determine the change in the group capability to play back media content comprise program instructions that are executable by the at least one processor such that the playback device is configured to determine that at least one other playback device has been added to, or removed from, the synchrony group.

(Feature 7) The playback device of feature 6, wherein (i) the determined group capability includes a capability to play back spatial audio content, (ii) the first selected rendition is a spatial audio rendition of the requested media item, and (iii) the program instructions that are executable by the at least one processor such that the playback device is configured to determine that at least one other playback device has been added to, or removed from, the synchrony group comprise program instructions that are executable by the at least one processor such that the playback device is configured to determine that at least one other playback device has been added to the synchrony group such that the changed group capability no longer includes the capability to play back spatial audio content, and wherein the second selected rendition is a non-spatial audio rendition of the requested media item.

(Feature 8) The playback device of feature 1, wherein (i) each group member in the synchrony group includes hardware to enable playback of spatial audio content, (ii) the program instructions that are executable by the at least one processor such that the playback device is configured to obtain the respective indication of each group member's capability to play back media content comprise program instructions that are executable by the at least one processor such that the playback device is configured to determine a selection of a user preference for at least one of the group members in the synchrony group not to play back spatial audio content, and (iii) the program instructions that are executable by the at least one processor such that the playback device is configured to select the rendition of the requested media item for playback comprise program instructions that are executable by the at least one processor such that the playback device is configured to select a non-spatial audio rendition of the requested media item.

(Feature 9) The playback device of feature 1, wherein the list of different renditions of the requested media item comprises (i) at least one spatial audio rendition of the requested media item and (ii) at least one non-spatial audio rendition of the requested media item.

(Feature 10) The playback device of feature 9, wherein the program instructions that are executable by the at least one processor such that the playback device is configured to select, from the list, a rendition of the requested media item for playback that corresponds to the determined group capability comprise program instructions that are executable by the at least one processor such that the playback device is configured to (i) if the determined group capability comprises a capability to play back spatial audio content, select a spatial audio rendition of the requested media item having a lowest bit rate among spatial audio renditions in the list, or (ii) if the determined group capability does not comprise the capability to play back spatial audio content, select a non-spatial audio rendition of the requested media item having a lowest bit rate among non-spatial audio renditions in the list.

(Feature 11) The playback device of feature 9, further comprising program instructions stored on the non-transitory computer-readable medium that are executable by the at least one processor such that the playback device is configured to (i) obtain an indication of a reference loudness value to be used for playback of media content, and either (ii) if a spatial audio rendition of the requested media item is selected, apply a predetermined gain offset to adjust a loudness of the spatial audio rendition to meet the reference loudness value, or (iii) if a non-spatial audio rendition of the requested media item is selected, (a) determine a baseline loudness of the non-spatial audio rendition of the requested media item, (b) determine a gain offset to adjust the baseline loudness of the non-spatial audio rendition of the requested media item to meet the reference loudness value, and (c) apply the determined gain offset to non-spatial audio rendition of the requested media item.

(Feature 12) A non-transitory computer-readable medium, wherein the non-transitory computer-readable medium is provisioned with program instructions that, when executed by at least one processor, cause a playback device to (i) operate as part of a synchrony group that comprises the playback device as a first group member and at least one other group member, (ii) obtain a respective indication of each group member's capability to play back media content, (iii) based on the respective indications of each group member's capability to play back media content, determine a group capability to play back media content, (iv) transmit, to a cloud-based computing system associated with a media service provider, a request for a media item to be played back by the synchrony group, (v) receive, from the cloud-based computing system associated with a media service provider, a list of different renditions of the requested media item, the list including a respective media item identifier that is usable to obtain each different rendition of the requested media item, (vi) select, from the list, a rendition of the requested media item for playback that corresponds to the determined group capability, (vii) use a media item identifier corresponding to the selected rendition of the requested media item to retrieve the selected rendition of the requested media item, and (viii) play back the selected rendition of the requested media item in synchrony with the at least one other group member.

(Feature 13) The non-transitory computer-readable medium of feature 12, wherein the request for the media item to be played back by the synchrony group comprises an indication of the determined group capability to play back media content.

(Feature 14) The non-transitory computer-readable medium of feature 12, wherein each media item identifier comprises a uniform resource indicator (URI).

(Feature 15) The non-transitory computer-readable medium of feature 12, wherein the selected rendition is a first selected rendition, and wherein the non-transitory computer-readable medium is also provisioned with program instructions that, when executed by at least one processor, cause the playback device to (i) during playback of the first selected rendition of the requested media item, determine a change in the group capability to play back media content, (ii) based on the determined change in the group capability to play back media content, select, from the list of different renditions, a second rendition of the requested media item for playback that corresponds to the changed group capability, (iii) use the media item identifier corresponding to the second selected rendition of the requested media item retrieve the second selected rendition of the requested media item, and (iv) transition from playing back the first selected rendition of the requested media item in synchrony with the at least one other group member to playing back the second selected rendition of the requested media item in synchrony with the at least one other group member.

(Feature 16) The non-transitory computer-readable medium of feature 15, wherein the program instructions that, when executed by at least one processor, cause the playback device to determine the change in the group capability to play back media content comprise program instructions that, when executed by at least one processor, cause the playback device to determine that a buffer of at least one group member in the synchrony group does not include a threshold amount of the selected rendition of the requested media item, wherein the second selected rendition of the requested media items comprises a lower bit rate rendition than the first selected rendition.

(Feature 17) The non-transitory computer-readable medium of feature 15, wherein the program instructions that, when executed by at least one processor, cause the playback device to determine the change in the group capability to play back media content comprise program instructions that, when executed by at least one processor, cause the playback device to determine that at least one other playback device has been added to, or removed from, the synchrony group.

(Feature 18) The non-transitory computer-readable medium of feature 17, wherein (i) the determined group capability includes a capability to play back spatial audio content, (ii) the first selected rendition is a spatial audio rendition of the requested media item, and (iii) the program instructions that are executable by the at least one processor such that the playback device is configured to determine that at least one other playback device has been added to, or removed from, the synchrony group comprise program instructions that are executable by the at least one processor such that the playback device is configured to determine that at least one other playback device has been added to the synchrony group such that the changed group capability no longer includes the capability to play back spatial audio content, and wherein the second selected rendition is a non-spatial audio rendition of the requested media item.

(Feature 19) The non-transitory computer-readable medium of feature 12, wherein (i) each group member in the synchrony group includes hardware to enable playback of spatial audio content, (ii) the program instructions that are executable by the at least one processor such that the playback device is configured to obtain the respective indication of each group member's capability to play back media content comprise program instructions that are executable by the at least one processor such that the playback device is configured to determine a selection of a user preference for at least one of the group members in the synchrony group not to play back spatial audio content, and (iii) the program instructions that are executable by the at least one processor such that the playback device is configured to select the rendition of the requested media item for playback comprise program instructions that are executable by the at least one processor such that the playback device is configured to select a non-spatial audio rendition of the requested media item.

(Feature 20) A method carried out by a playback device, the method comprising (i) operating as part of a synchrony group that comprises the playback device as a first group member and at least one other group member, (ii) obtaining a respective indication of each group member's capability to play back media content, (iii) based on the respective indications of each group member's capability to play back media content, determining a group capability to play back media content, (iv) transmitting, to a cloud-based computing system associated with a media service provider, a request for a media item to be played back by the synchrony group, (v) receiving, from the cloud-based computing system associated with a media service provider, a list of different renditions of the requested media item, the list including a respective media item identifier that is usable to obtain each different rendition of the requested media item, (vi) selecting, from the list, a rendition of the requested media item for playback that corresponds to the determined group capability, (vii) using a media item identifier corresponding to the selected rendition of the requested media item to retrieve the selected rendition of the requested media item, and (viii) playing back the selected rendition of the requested media item in synchrony with the at least one other group member.

1. A playback device comprising:
at least one processor;
a non-transitory computer-readable medium; and
program instructions stored on the non-transitory computer-readable medium that are executable by the at least one processor such that the playback device is configured to:
operate as part of a synchrony group that comprises the playback device as a first group member and at least one other group member;
obtain a respective indication of each group member's capability to play back media content;
based on the respective indications of each group member's capability to play back media content, determine a group capability to play back media content;
transmit, to a cloud-based computing system associated with a media service provider, a request for a media item to be played back by the synchrony group;
receive, from the cloud-based computing system associated with a media service provider, a list of different renditions of the requested media item, the list including a respective media item identifier that is usable to obtain each different rendition of the requested media item;
select, from the list, a rendition of the requested media item for playback that corresponds to the determined group capability;
use a media item identifier corresponding to the selected rendition of the requested media item to retrieve the selected rendition of the requested media item; and
play back the selected rendition of the requested media item in synchrony with the at least one other group member.

2. The playback device of claim 1, wherein the request for the media item to be played back by the synchrony group comprises an indication of the determined group capability to play back media content.

3. The playback device of claim 1, wherein each media item identifier comprises a uniform resource indicator (URI).

4. The playback device of claim 1, wherein the selected rendition is a first selected rendition, the playback device further comprising program instructions stored on the non-transitory computer-readable medium that are executable by the at least one processor such that the playback device is configured to:
during playback of the first selected rendition of the requested media item, determine a change in the group capability to play back media content;
based on the determined change in the group capability to play back media content, select, from the list of different renditions, a second rendition of the requested media item for playback that corresponds to the changed group capability;
use the media item identifier corresponding to the second selected rendition of the requested media item retrieve the second selected rendition of the requested media item; and
transition from playing back the first selected rendition of the requested media item in synchrony with the at least one other group member to playing back the second selected rendition of the requested media item in synchrony with the at least one other group member.

5. The playback device of claim 4, wherein the program instructions that are executable by the at least one processor such that the playback device is configured to determine the change in the group capability to play back media content comprise program instructions that are executable by the at least one processor such that the playback device is configured to:
determine that a buffer of at least one group member in the synchrony group does not include a threshold amount of the selected rendition of the requested media item, wherein the second selected rendition of the requested media items comprises a lower bit rate rendition than the first selected rendition.

6. The playback device of claim 4, wherein the program instructions that are executable by the at least one processor such that the playback device is configured to determine the change in the group capability to play back media content comprise program instructions that are executable by the at least one processor such that the playback device is configured to:
determine that at least one other playback device has been added to, or removed from, the synchrony group.

7. The playback device of claim 6, wherein the determined group capability includes a capability to play back spatial audio content, and wherein the first selected rendition is a spatial audio rendition of the requested media item; and
wherein the program instructions that are executable by the at least one processor such that the playback device is configured to determine that at least one other playback device has been added to, or removed from, the synchrony group comprise program instructions that are executable by the at least one processor such that the playback device is configured to determine that at least one other playback device has been added to the synchrony group such that the changed group capability no longer includes the capability to play back spatial audio content, and wherein the second selected rendition is a non-spatial audio rendition of the requested media item.

8. The playback device of claim 1, wherein each group member in the synchrony group includes hardware to enable playback of spatial audio content, and wherein the program instructions that are executable by the at least one processor such that the playback device is configured to obtain the respective indication of each group member's capability to play back media content comprise program instructions that are executable by the at least one processor such that the playback device is configured to determine a selection of a user preference for at least one of the group members in the synchrony group not to play back spatial audio content; and
wherein the program instructions that are executable by the at least one processor such that the playback device is configured to select the rendition of the requested media item for playback comprise program instructions that are executable by the at least one processor such that the playback device is configured to select a non-spatial audio rendition of the requested media item.

9. The playback device of claim 1, wherein the list of different renditions of the requested media item comprises (i) at least one spatial audio rendition of the requested media item and (ii) at least one non-spatial audio rendition of the requested media item.

10. The playback device of claim 9, wherein the program instructions that are executable by the at least one processor such that the playback device is configured to select, from the list, a rendition of the requested media item for playback that corresponds to the determined group capability comprise program instructions that are executable by the at least one processor such that the playback device is configured to:
if the determined group capability comprises a capability to play back spatial audio content, select a spatial audio rendition of the requested media item having a lowest bit rate among spatial audio renditions in the list; or
if the determined group capability does not comprise the capability to play back spatial audio content, select a non-spatial audio rendition of the requested media item having a lowest bit rate among non-spatial audio renditions in the list.

11. The playback device of claim 9, further comprising program instructions stored on the non-transitory computer-readable medium that are executable by the at least one processor such that the playback device is configured to:
obtain an indication of a reference loudness value to be used for playback of media content; and
if a spatial audio rendition of the requested media item is selected, apply a predetermined gain offset to adjust a loudness of the spatial audio rendition to meet the reference loudness value; or
if a non-spatial audio rendition of the requested media item is selected:
determine a baseline loudness of the non-spatial audio rendition of the requested media item;
determine a gain offset to adjust the baseline loudness of the non-spatial audio rendition of the requested media item to meet the reference loudness value; and
apply the determined gain offset to non-spatial audio rendition of the requested media item.

12. At least one non-transitory computer-readable medium, wherein the at least one non-transitory computer-readable medium is provisioned with program instructions that, when executed by at least one processor, cause a playback device to:
operate as part of a synchrony group that comprises the playback device as a first group member and at least one other group member;
obtain a respective indication of each group member's capability to play back media content;
based on the respective indications of each group member's capability to play back media content, determine a group capability to play back media content;
transmit, to a cloud-based computing system associated with a media service provider, a request for a media item to be played back by the synchrony group;
receive, from the cloud-based computing system associated with a media service provider, a list of different renditions of the requested media item, the list including a respective media item identifier that is usable to obtain each different rendition of the requested media item;
select, from the list, a rendition of the requested media item for playback that corresponds to the determined group capability;
use a media item identifier corresponding to the selected rendition of the requested media item to retrieve the selected rendition of the requested media item; and
play back the selected rendition of the requested media item in synchrony with the at least one other group member.

13. The non-transitory computer-readable medium of claim 12, wherein the request for the media item to be played back by the synchrony group comprises an indication of the determined group capability to play back media content.

14. The non-transitory computer-readable medium of claim 12, wherein the selected rendition is a first selected rendition, and wherein the non-transitory computer-readable medium is also provisioned with program instructions that, when executed by the at least one processor, cause the playback device to:
during playback of the first selected rendition of the requested media item, determine a change in the group capability to play back media content;
based on the determined change in the group capability to play back media content, select, from the list of different renditions, a second rendition of the requested media item for playback that corresponds to the changed group capability;
use the media item identifier corresponding to the second selected rendition of the requested media item retrieve the second selected rendition of the requested media item; and
transition from playing back the first selected rendition of the requested media item in synchrony with the at least one other group member to playing back the second selected rendition of the requested media item in synchrony with the at least one other group member.

15. The non-transitory computer-readable medium of claim 14, wherein the program instructions that, when executed by the at least one processor, cause the playback device to determine the change in the group capability to play back media content comprise program instructions that, when executed by the at least one processor, cause the playback device to:
determine that a buffer of at least one group member in the synchrony group does not include a threshold amount of the selected rendition of the requested media item, wherein the second selected rendition of the requested media items comprises a lower bit rate rendition than the first selected rendition.

16. The non-transitory computer-readable medium of claim 14, wherein the program instructions that, when executed by the at least one processor, cause the playback device to determine the change in the group capability to play back media content comprise program instructions that, when executed by the at least one processor, cause the playback device to:
determine that at least one other playback device has been added to, or removed from, the synchrony group.

17. The non-transitory computer-readable medium of claim 16, wherein the determined group capability includes a capability to play back spatial audio content, and wherein the first selected rendition is a spatial audio rendition of the requested media item; and
wherein the program instructions that, when executed by the at least one processor, cause the playback device to determine that at least one other playback device has been added to, or removed from, the synchrony group comprise program instructions that, when executed by the at least one processor, cause the playback device to determine that at least one other playback device has been added to the synchrony group such that the changed group capability no longer includes the capability to play back spatial audio content, and wherein the second selected rendition is a non-spatial audio rendition of the requested media item.

18. The non-transitory computer-readable medium of claim 12, wherein each group member in the synchrony group includes hardware to enable playback of spatial audio content, and wherein the program instructions that, when executed by at least one processor, cause the playback device to obtain the respective indication of each group member's capability to play back media content comprise program instructions that, when executed by the at least one processor, cause the playback device to determine a selection of a user preference for at least one of the group members in the synchrony group not to play back spatial audio content; and
wherein the program instructions that, when executed by the at least one processor, cause the playback device to select the rendition of the requested media item for playback comprise program instructions that, when executed by the at least one processor, cause the playback device to select a non-spatial audio rendition of the requested media item.

19. The non-transitory computer-readable medium of claim 12, wherein the list of different renditions of the requested media item comprises (i) at least one spatial audio rendition of the requested media item and (ii) at least one non-spatial audio rendition of the requested media item, and wherein the program instructions that, when executed by the at least one processor, cause the playback device to select, from the list, a rendition of the requested media item for playback that corresponds to the determined group capability comprise program instructions that, when executed by the at least one processor, cause the playback device to:
if the determined group capability comprises a capability to play back spatial audio content, select a spatial audio rendition of the requested media item having a lowest bit rate among spatial audio renditions in the list; or
if the determined group capability does not comprise the capability to play back spatial audio content, select a non-spatial audio rendition of the requested media item having a lowest bit rate among non-spatial audio renditions in the list.

20. A method carried out by a playback device, the method comprising:
operating as part of a synchrony group that comprises the playback device as a first group member and at least one other group member;
obtaining a respective indication of each group member's capability to play back media content;
based on the respective indications of each group member's capability to play back media content, determining a group capability to play back media content;
transmitting, to a cloud-based computing system associated with a media service provider, a request for a media item to be played back by the synchrony group;
receiving, from the cloud-based computing system associated with a media service provider, a list of different renditions of the requested media item, the list including a respective media item identifier that is usable to obtain each different rendition of the requested media item;
selecting, from the list, a rendition of the requested media item for playback that corresponds to the determined group capability;
using a media item identifier corresponding to the selected rendition of the requested media item to retrieve the selected rendition of the requested media item; and
playing back the selected rendition of the requested media item in synchrony with the at least one other group member.
